(19) United States
(12) Patent Application Publication
(10) Pub. No.: US 2014/0050974 A1
(43) Pub. Date: Feb. 20, 2014

(54) SODIUM SECONDARY BATTERY

(71) Applicants: Takuhiro Miyuki, Ikeda-shi (JP); Toshikatsu Kojima, Ikeda-shi (JP); Yasue Okuyama, Ikeda-shi (JP); Tetsuo Sakai, Ikeda-shi (JP); Masataka Nakanishi, Kariya-shi (JP); Junichi Niwa, Kariya-shi (JP); Kazuhito Kawasumi, Kariya-shi (JP); Satoshi Nakagawa, Kariya-shi (JP); Akira Kojima, Kariya-shi (JP)

(72) Inventors: Takuhiro Miyuki, Ikeda-shi (JP); Toshikatsu Kojima, Ikeda-shi (JP); Yasue Okuyama, Ikeda-shi (JP); Tetsuo Sakai, Ikeda-shi (JP); Masataka Nakanishi, Kariya-shi (JP); Junichi Niwa, Kariya-shi (JP); Kazuhito Kawasumi, Kariya-shi (JP); Satoshi Nakagawa, Kariya-shi (JP); Akira Kojima, Kariya-shi (JP)

(73) Assignees: NATIONAL INSTITUTE OF ADVANCED INDUSTRIAL SCIENCE AND TECHNOLOGY, Chiyoda-ku, Tokyo (JP); KABUSHIKI KAISHA TOYOTA JIDOSHOKKI, Kariya-shi, Aichi (JP)

(21) Appl. No.: 14/114,099

(22) PCT Filed: Jan. 12, 2012
(86) PCT No.: PCT/JP2012/000155

§ 371 Date: Oct. 25, 2013

(30) Foreign Application Priority Data
Apr. 27, 2011 (JP) 2011-099063

(51) Int. Cl. H01M 4/583

(52) U.S. Cl. CPC H01M 4/583
USPC 429/188

(57) ABSTRACT

Because of being equipped with a positive electrode, a negative electrode and a sodium-ion nonaqueous electrolyte, and because the positive electrode includes a sulfur-based positive-electrode active material containing carbon (C) and sulfur (S), it is possible to inhibit sulfur from eluting out into electrolytic solution, thereby resulting in a sodium secondary battery that makes it feasible to undergo charging and discharging for 100 cycles or more reversibly.

### TECHNICAL FIELD

The present invention is one which relates to a sodium secondary battery, involving sodium-ion secondary batteries.

### BACKGROUND ART

A lithium-ion secondary battery, one type of nonaqueous electrolyte secondary batteries, is a battery whose charging and discharging capacities are large, and has been used as a battery for portable electronic devices mainly. Moreover, lithium-ion secondary batteries have also been expected as a battery for electric automobiles, respectively. However, the resources of lithium are localized in specific regions on the earth, so that lithium has been becoming expensive.

Hence, instead of lithium, the development of sodium-ion secondary battery, which uses sodium that exists in seawater inexhaustibly, has been sought for. It has been believed that sodium-ion secondary battery makes it possible to demonstrate as an entire cell from 70 to 80% of the performance of lithium-ion secondary battery, although the standard oxidation-reduction potential of sodium is lower by 0.33 V and the density is higher by about 80%, compared with those of lithium. For example, a negative-electrode current collector for sodium-ion secondary battery is proposed in Japanese Unexamined Patent Publication (KOKAI) Gazette No. 2010-225525 (i.e., Patent Literature No. 1); and an electrolytic solution for sodium-ion secondary battery is proposed in Japanese Unexamined Patent Publication (KOKAI) Gazette No. 2010-165674 (i.e., Patent Literature No. 2).

Moreover, in International Publication No. 2010/044437 (i.e., Patent Literature No. 3), the following are set forth: a reactant between polyacrylonitrile (hereinafter being referred to as “PAN”) and sulfur functions as a positive-electrode active material for lithium-ion battery.

### RELATED TECHNICAL LITERATURE

### Patent Literature

Patent Literature No. 1: Japanese Unexamined Patent Publication (KOKAI) Gazette No. 2010-225525;
Patent Literature No. 2: Japanese Unexamined Patent Publication (KOKAI) Gazette No. 2010-165674; and
Patent Literature No. 3: International Publication No. 2010/044437

### SUMMARY OF THE INVENTION

### Assignment to be Solved by the Invention

However, since Na⁺ (sodium ion) has an ionic radius that is larger by about 1.7 times compared with that of Li⁺ (lithium ion), the coming in and going out from active material is more limited than that of Li⁺. For example, graphite, which has been used as a negative-electrode active material for lithium-ion secondary battery, makes a layered structure, and Li⁺ comes in and goes out from spaces between its layers. However, it is difficult for Na⁺ to come in and go out from spaces between the layers of graphite.

Hence, in Patent Literature No. 1, a sodium-ion secondary battery is proposed, sodium-ion secondary battery in which a sodium metal or the like is used as the negative-electrode active material and a sodium inorganic compound, such as a sodium-manganese composite oxide, is used as the positive-electrode active material; and it is set forth therein that 10 cycles of charging and discharging were ascertained.

The present invention is one which has been done in view of such circumstances. It is therefore an assignment to be solved to provide a sodium secondary battery that includes a novel positive-electrode active material, and which makes it feasible to undergo charging and discharging for 100 cycles or more.

### Means for Solving the Assignment

Characteristics of a sodium secondary battery according to the present invention solving the aforementioned assignment lie in that:

the sodium secondary battery is equipped with:
a positive electrode;
a negative electrode; and
a sodium-ion nonaqueous electrolyte; and

the positive electrode includes a sulfur-based positive-electrode active material containing carbon (C) and sulfur (S).

### Effect of the Invention

Since the sodium secondary battery according to the present invention has a positive electrode including a sulfur-based positive-electrode active material that contains carbon (C) and sulfur (S), it can inhibit sulfur from eluting out into electrolytic solution, so that it can cause the cyclability to upgrade.

### BRIEF DESCRIPTION OF THE DRAWINGS

FIG. 1 illustrates a Raman spectrum of a sulfur-based positive-electrode active material comprising a carbon skeleton that is derived from “PAN,” and sulfur (S) that is bonded to that carbon skeleton;

FIG. 2 is a Raman spectrum of a sulfur-based positive-electrode active material being directed to Example No. 1;

FIG. 3 is an explanatory diagram for schematically expressing a reaction apparatus that was used in a production process for a sulfur-based positive-electrode active material according to examples;

FIG. 4 is a graph for expressing charging and discharging curves of a sodium secondary battery being directed to Example No. 1;

FIG. 5 is a graph for expressing results of acyclic test for the sodium secondary battery being directed to Example No. 1;

FIG. 6 is a graph for expressing charging and discharging curves of a sodium secondary battery being directed to Example No. 2;

FIG. 7 is a graph for expressing results of a cyclic test for the sodium secondary battery being directed to Example No. 2;

FIG. 8 is a graph for expressing charging and discharging curves of a sodium secondary battery being directed to Example No. 3;

FIG. 9 is a graph for expressing results of acyclic test for the sodium secondary battery being directed to Example No. 3;

FIG. 10 is a graph for expressing charging and discharging curves of a sodium secondary battery being directed to Example No. 4; and

FIG. 11 is a graph for expressing results of a cyclic test for the sodium secondary battery being directed to Example No. 4.

### MODE FOR CARRYING OUT THE INVENTION

A sodium secondary battery according to the present invention is equipped with a positive electrode, a negative electrode, and a sodium-ion nonaqueous electrolyte; and the positive electrode includes a sulfur-based positive-electrode active material containing carbon (C) and sulfur (S). As for the sulfur-based positive-electrode active material, although it is possible to name carbon polysulfides, sulfur elementary substances, those in which vegetative materials, such as coffee beans and seaweeds, and sulfur have been heat treated, or composites of these, and the like, it is desirable to use one comprising:

a carbon skeleton being derived from a carbon-source compound that is selected from the group consisting of “PAN” (i), pitches (ii), polyisoprene (iii), and a polycyclic aromatic hydrocarbon (iv) that is made by condensing six-membered rings in a quantity of three rings or more; and

sulfur (S) being bonded to the carbon skeleton.

It is possible to produce a sulfur-based positive-electrode active material, which comprises a carbon skeleton being derived from “PAN” (i) and sulfur (S) being bonded to that carbon skeleton, by a production process being set forth in Patent Literature No. 3. That is, it can be produced by mixing a raw-material powder including a sulfur powder and a “PAN” powder to make a mixed raw material, and then heating the mixed raw material under a nonoxidizing atmosphere while preventing sulfur vapors from flowing out. By means of this, sulfur in the form of vapor reacts with “PAN”, simultaneously with the ring-closing reaction of “PAN”, and thereby “PAN”, which has been modified by means of sulfur, is obtainable.

Although it is not restrictive at all as to a particle diameter of the sulfur powder, upon classifying it using a sieve, one falling within a range of from 150 μm to 40 μm approximately is preferable, and another falling within a range of from 100 μm to 40 μm approximately is more preferable.

As for the “PAN” powder, one whose weight average molecular weight falls within a range of from 10,000 to 300,000 is preferable. Moreover, as to a particle diameter of “PAN”, upon observing it by means of an electron microscope, one falling within a range of from 0.5 μm to 50 μm approximately is preferable, and another falling within a range of from 1 μm to 10 μm approximately is more preferable. When the molecular weight and particle diameter of “PAN” fall within these ranges, “PAN” and sulfur are able to be reacted one another with higher reliability, because it is possible to make the contact area between “PAN” and sulfur larger. Consequently, it is possible to suppress the elution of sulfur into electrolytic solution with much higher reliability.

Although it is not restrictive at all as to a mixing proportion between the sulfur powder and the “PAN” powder in the mixed powder, it is preferable to set the sulfur powder in an amount of from 50 to 1,000 parts by mass approximately; it is more preferable to set it in an amount of from 50 to 500 parts by mass approximately; and it is much more preferable to set it in an amount of from 150 to 350 parts by mass approximately; with respect to 100 parts by mass of the “PAN” powder.

As an example of methods for heating while preventing sulfur from flowing out, it is possible to employ a method of heating in a sealed atmosphere. In this case, as for the sealed atmosphere, it is allowable that a sealed state can be kept to such an extent that the vapors of sulfur, which are generated by means of heating, do not dissipate. As for a nonoxidizing atmosphere, it is permissible to set up one of the following: depressurized states whose oxide concentration is set to such an extent that oxidation reactions do not proceed; inert-gas atmospheres, such as nitrogen and argon; and sulfur-gas atmospheres, and so on.

It is not limited especially at all as to a specific method of making a sealed-state nonoxidizing atmosphere. For example, it is allowable that the mixed raw material can be put into a container in which sealability is kept to such an extent that the vapors of sulfur do not dissipate and then the mixed raw material can be heated after turning the inside of the container into a depressurized state or inert-gas atmosphere. Other than that, it is also permissible to heat the mixed raw material of the sulfur powder and “PAN” powder in such a state as it is vacuum packed with a material, such as an aluminum laminated film, which does not cause any reaction with the vapors of sulfur. In this case, lest the packaging material should be broken by means of the generated vapors of sulfur, it is preferable to put the packed raw material into a pressure-resistant container, such as an autoclave in which water has been held, for instance, and then to heat the packed raw material, thereby setting up a state where the packaging material is pressurized from the outside by generated water vapors. In accordance with this method, the packaging material can be prevented from being swollen to break by means of the vapors of sulfur, because the packaging material is pressurized from the outside by means of water vapors.

Although it is also allowable that the sulfur powder and “PAN” powder can be in such a state that they are simply mixed with each other, it is even permissible that the mixed raw material can be turned into a state in which it has been formed as a pelletized shape, for instance. Moreover, it is also allowable that the mixed raw material can be constituted of “PAN” and sulfur alone, or it is even permissible to further compound a common material (e.g., an electrically-conductive additive, and the like) that is compoundable in positive-electrode active materials.

It is preferable to set a heating temperature at from 250 to 500° C. approximately; it is more preferable to set it at from 250 to 450° C. approximately; and it is much more preferable to set it at from 250 to 400° C. approximately. Although it is not restrictive at all as to a heating time and the heating time depends on actual heating temperatures, it is allowable to do retaining for from 10 minutes to 10 hours approximately; and it is preferable to do retaining for from 30 minutes to 6 hours; within one of the aforementioned temperature ranges. In accordance with this method according to the present invention, it is feasible to form sulfur-modified “PAN” in such a short period of time.

Moreover, as another example of doing heating while preventing sulfur from flowing out, it is possible to employ another method in which the mixed raw material including the sulfur powder and “PAN” powder is heated while refluxing the vapors of sulfur within a reaction container having an opening that discharges hydrogen sulfide being generated by means of reactions. In this case, it is allowable to dispose the opening for discharging hydrogen sulfide at a position where the generated sulfur vapors are liquefied fully substantially to be refluxed so that it is possible to prevent the vapors of sulfur from flowing out through the opening. For example, by means of disposing the opening at such a portion at which a temperature inside the reaction container becomes 100° C. or less approximately, it is possible to return the sulfur vapors into the reaction container without ever being discharged to the outside, because, as to hydrogen sulfide that is generated by means of reactions, the hydrogen sulfide is discharged to the outside through the opening but the vapors of sulfur condense at the opening portion.

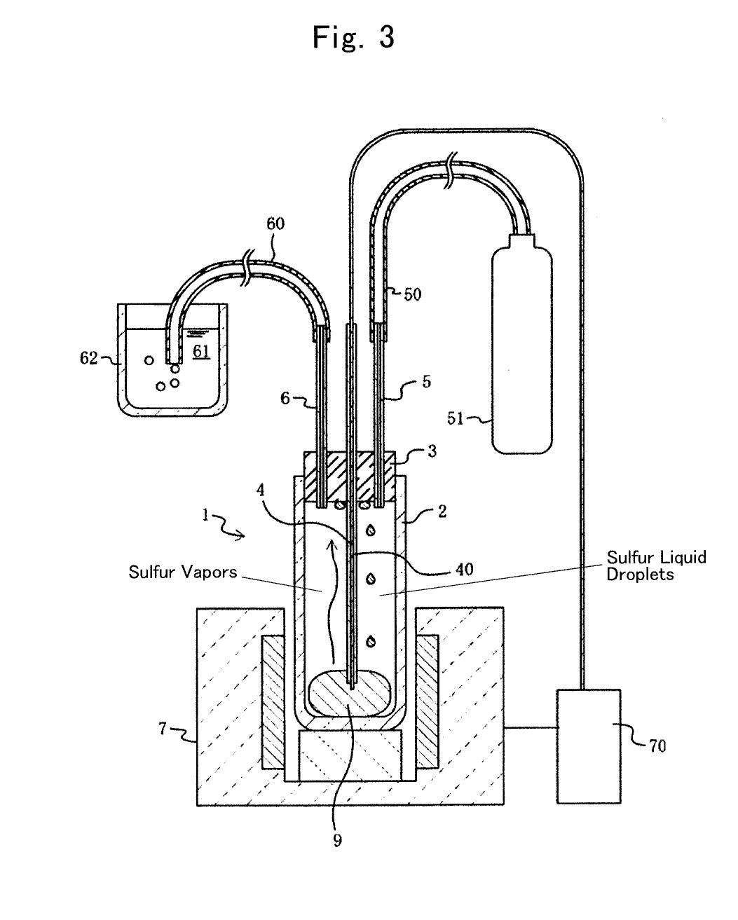

An outlined diagram of the reaction container according to an example that can be employed in this method is shown in FIG. 3. In the apparatus being shown in FIG. 3, a reaction container accommodating a mixed-raw-material powder therein is put in an electric furnace, and the reaction container's top is put in a state of being exposed from out of the electric furnace. By means of using an apparatus like this, the reaction container's top becomes a lower temperature than the other temperatures of the reaction container inside the electric furnace. On this occasion, it is allowable that a temperature at the reaction container's top can be a temperature at which the vapors of sulfur liquefy. In the reaction apparatus being shown in FIG. 3, the reaction container is plugged with a plug made of silicone rubber at the top; and an opening for discharging hydrogen sulfide, and another opening for introducing an inert gas are disposed in this plug. In addition, a thermocouple is put in place in the silicone-rubber plug in order to measure the temperature of the mixed raw material. Since the plug made of silicone rubber has a downwardly-protruding configuration, sulfur, which condenses to liquefy at this portion, falls in drops toward the container's bottom. For the reaction container, it is preferable to use a material that is strong against heat and corrosions resulting from sulfur, such as Tammann tubes made of alumina, and heat-resistant glass tubes, for instance. The silicone-rubber plug is subjected to a treatment for corrosion prevention with a tape made of fluororesin, for instance.

In order to turn the inside of the reaction container into a nonoxidizing atmosphere, it is allowable to make an inert-gas atmosphere by introducing an inert gas, such as nitrogen, argon and helium, through the inert-gas introduction opening in the initial period of heating, for instance. Since the vapors of sulfur are generated gradually when the raw materials' temperature rises, it is preferable to close the inert-gas introduction opening when the raw materials' temperature becomes 100° C. or more approximately, in order to keep the inert-gas introduction opening from being blocked by means of precipitated sulfur. The inert gas is discharged along with generating hydrogen sulfide by means of doing heating continuously thereafter, so that the inside of the reaction container turns into a sulfur-vapor atmosphere mainly.

In the same manner as the method where heating is done in a sealed atmosphere, it is preferable to set a heating temperature in this case as well at from 250 to 500° C. approximately; it is more preferable to set it at from 250 to 450° C. approximately; and it is much more preferable to set it at from 250 to 400° C. approximately. As to a reaction time, too, it is permissible to do retaining in a temperature range of from 250 to 500° C. for from 10 minutes to 10 hours approximately in the same manner as the aforementioned method. However, under normal circumstances, the mixed raw material comes to be retained in the aforementioned temperature range for a required time when the heating is stopped after the interior of the reaction container has reached the aforementioned temperature range, because reactions are accompanied by heat generations. Moreover, it is necessary to control heating conditions so as to make a maximum temperature, involving a rise by a temperature increment resulting from exothermic reactions, reach the above-described heating temperature. Note that a temperature increment rate of 10° C. or less for every minute is desirable because reactions are accompanied by heat generations.

In this method, it is possible to facilitate the reactions between the sulfur powder and “PAN” more than the case where the reactions are carried out within a sealed container, because superfluous hydrogen sulfide gases, which have arisen during the reactions, are removed so that such a state is retained that the inside of the reaction container is filled up with the liquid and vapor of sulfur.

It is advisable to dispose of hydrogen sulfide, which has been discharged from the reaction container, by forming a deposit of sulfur, for example, by means of passing it through hydrogen peroxide water, an alkali aqueous solution, or the like.

The heating is cut off after the interior of the reaction container has reached a predetermined temperature, and then natural cooling is done. Thus, a mixture of generated sulfur-modified “PAN” and sulfur can be taken out.

As a result of elemental analysis, the obtained sulfur-modified “PAN” includes carbon, nitrogen, and sulfur. Moreover, a case may also arise where it further includes a small amount of oxygen and hydrogen.

Of the aforementioned production processes, in accordance with the method where heating is done in a sealed atmosphere, the obtainable sulfur-modified “PAN” comes to comprise carbon in a range of from 40 to 60% by mass, sulfur in a range of from 15 to 30% by mass, nitrogen in a range of from 10 to 25% by mass, and hydrogen in a range of from 1 to 5% by mass approximately, taken as the contents in the sulfur-modified “PAN,” according to a result of elemental analysis.

Moreover, of the aforementioned production processes, the content of sulfur becomes greater in the obtainable sulfur-modified “PAN,” in accordance with the method where heating is done while discharging hydrogen sulfide gases. According to a result of elemental analysis and calculation by means of XPS measurement, carbon comes to fall in a range of from 25 to 50% by mass, sulfur in a range of from 25 to 55% by mass, nitrogen in a range of from 10 to 20% by mass, oxygen in a range of from 0 to 5% by mass, and hydrogen in a range of from 0 to 5% by mass, taken as the contents in the sulfur-modified “PAN.” The sulfur-modified “PAN” with greater sulfur content, which is obtainable by this method, has an electric capacity that becomes larger upon employing it as a positive-electrode active material.

Moreover, in the obtainable sulfur-modified “PAN,” a weight reduction, which results from thermogravimetric analysis upon heating the “PAN” from room temperature up to 900° C. at a temperature increment rate of 20° C./minute, is 10% or less at the time of 400° C. Meanwhile, when heating the mixed raw material of the sulfur powder and “PAN” powder under the same conditions, a weight decrement can be appreciated at around 120° C.; and a greater weight reduction, which results from the disappearance of sulfur, can be appreciated suddenly when the temperature becomes 200° C. or more.

In addition, as a result of X-ray diffraction by means of the CuKα ray, it is ascertained that, in the sulfur-modified “PAN,” a peak resulting from sulfur disappears and accordingly a broad peak alone appears in a neighborhood region where the diffraction angle (2θ) is from 20 degrees to 30 degrees.

From these remarks, it is believed that, in the sulfur-modified “PAN” being obtainable by the aforementioned methods, the sulfur does not exist as the elementary substance, but exists in such a state that it has bonded to “PAN” in which the ring-closing reaction has proceeded.

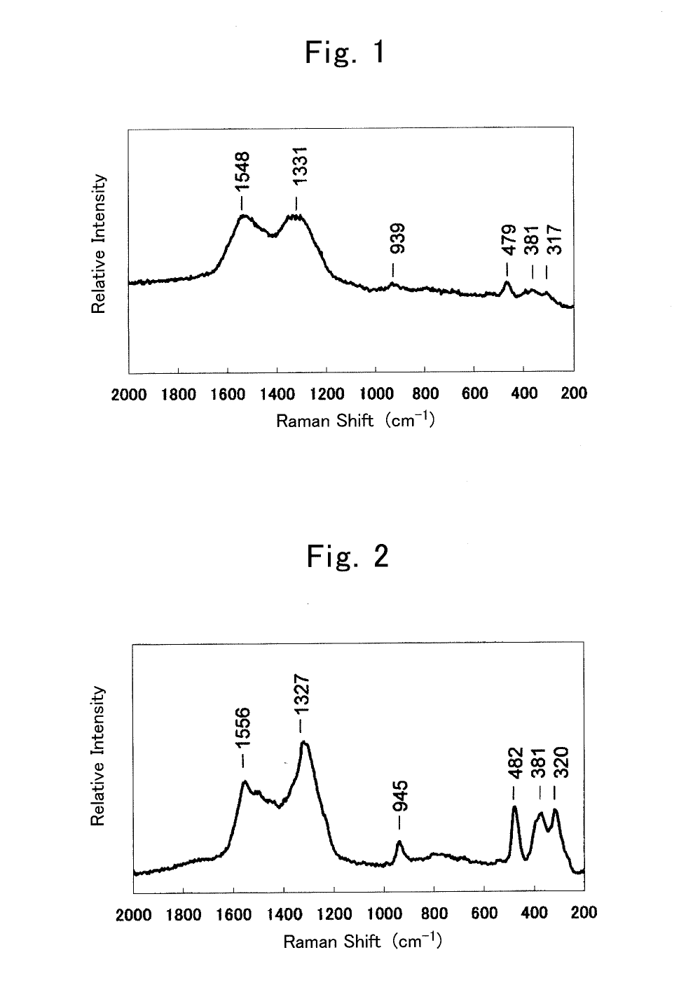

An example of a Raman spectrum for the sulfur-modified “PAN,” which was obtained using sulfur atoms in an amount of 200 parts by weight with respect 100 parts by weight of “PAN,” is shown in FIG. 1. This sulfur-modified “PAN” is one being characterized in that it exhibits a Raman spectrum in which a major peak exists at around 1,331 cm⁻¹, one of the Raman shifts, and other peaks exist at around 1,548 cm⁻¹, 939 cm⁻¹, 479 cm⁻¹, 381 cm⁻¹ and 317 cm⁻¹, the others of the Raman shifts, in a range of from 200 cm⁻¹ to 1,800 cm⁻¹. In the present description, the “major peak” is referred to as a peak whose peak height is the maximum in all the peaks that have appeared in a Raman spectrum.

With regard to the aforementioned Raman-shift peaks, they are the ones that are observed at the same peak positions even in a case where the proportion of sulfur atoms with respect to “PAN” is altered, and they are the ones that characterize the sulfur-modified “PAN.” When the aforementioned peak positions are regarded as the center, respectively, it is possible for each of the aforementioned peaks to exist within a range of ±8 cm⁻¹ roughly about the center. Note that the aforementioned Raman shifts are those which were measured by “RMP-320,” a product of JASCO Corporation, whose excitation wavelength λ was 532 nm, grating was 1,800 gr/mm, and resolution was 3 cm⁻¹. Note that, in Raman spectra, the number of peaks may change, or the position of peak top may deviate, depending on the differences between the wavelengths of incident light or between the resolutions.

Since it is possible for a sodium secondary battery possessing a positive electrode in which the sulfur-modified “PAN” makes the active material to maintain a high capacity that sulfur has intrinsically, and since the elution of sulfur into electrolytic solution is inhibited, the cyclability upgrades greatly. This is believed to be due to the fact that, within the sulfur-based positive-electrode active material, the sulfur does not exist as the elementary substance but exists in such a stable state that it has bonded to “PAN.” In a production process for sulfur-based positive-electrode active material that is disclosed in Patent Literature No. 3, sulfur undergoes a heating treatment along with “PAN.” When heating “PAN,” it is believed that the “PAN” cross-links three-dimensionally so that it undergoes ring closing while forming a condensed ring (e.g., a six-membered ring, mainly). Consequently, it is believed that sulfur exists within the sulfur-based positive-electrode active material in such as state that it has bonded to “PAN” in which the ring-closing reaction has proceeded. Bonding “PAN” and sulfur to each other leads to making it possible to inhibit the elution of sulfur into electrolytic solution, and to making the resulting cyclability upgradable.

By means of these, the sulfur-modified “PAN” is inhibited from eluting out into non-water-based electrolytic solutions. Accordingly, it becomes feasible to make batteries using non-water-based electrolytic solutions for sodium secondary battery. Consequently, its practical values upgrade greatly.

In a case where unreacted sulfur exists in the sulfur-modified “PAN” that is obtainable by means of the aforementioned methods, it is possible to remove it by means of further heating the sulfur-modified “PAN” in a nonoxidizing atmosphere. Since it is thus possible to obtain the sulfur-modified “PAN” with much higher purity, a sodium secondary battery possessing a positive electrode in which this “PAN” is used as the positive-electrode active material is upgraded more in terms of the cyclability of charging and discharging.

As for a nonoxidizing atmosphere, it is advisable to set up one of the following: depressurized states whose oxygen concentration is set to such an extent that oxidation reactions do not proceed; and inert-gas atmospheres, such as nitrogen and argon, and so on, for instance.

It is preferable to set a heating temperature at from 150 to 400° C. approximately; it is more preferable to set it at from 150 to 300° C. approximately; and it is much more preferable to set it at from 200 to 300° C. approximately. Care should be taken, however, because the sulfur-modified “PAN” might possibly decompose when the heating temperature becomes higher too much.

Although it is not restrictive at all as to a heating time, it is usually preferable to set it for from 1 to 6 hours approximately.

As for pitches (ii), it is possible to use at least one member that is selected from the group consisting of the following: coal pitch; petroleum pitch; mesophase pitch; asphalt; coal tar; coal-tar pitch; organically synthesized pitch being obtainable by polycondensation of condensed polycyclic aromatic hydrocarbon compounds; and another organically synthesized pitch being obtainable by polycondensation of heteroatom-containing condensed polycyclic aromatic hydrocarbon compounds.

Coal tar, one of the species of pitches, is a black, sticky oily liquid being obtainable by subjecting coal to high-temperature destructive distillation (or coal dry distillation). It is possible to obtain coal pitch by subjecting coal tar to purification and/or heat treatment (e.g., polymerization).

Asphalt is a blackish brown or black solid, or a semi-solid plastic substance. Asphalt is divided roughly into one which is obtainable as tank residue when petroleum (or crude oil) is subjected to reduced-pressure distillation, and another one which exists naturally. Asphalt is soluble in toluene, carbon disulfide, and so on. It is possible to obtain petroleum pitch by subjecting asphalt to purification and/or heat treatment (e.g., polymerization).

Pitch is usually amorphous, and is isotropic optically (e.g., isotropic pitch). It is possible to obtain optically-anisotropic pitch (e.g., anisotropic pitch, and mesophase pitch) by heat treating isotropic pitch in inert atmosphere. Pitch is soluble partially in organic solvents, such as benzene, toluene and carbon disulfide.

Pitches are mixtures of various compounds, and include condensed polycyclic aromatic groups as described above. Condensed polycyclic aromatic groups being included in pitches can also be a single species, or can even be a plurality of species. For example, a major component of coal pitch, one of the species of pitches, is a condensed polycyclic group. It is possible for this condensed polycyclic aromatic group to include, other than carbon and hydrogen, nitrogen or sulfur within the rings. Thus, the major component of coal pitch is believed to be a mixture of condensed polycyclic aromatic hydrocarbon, which is composed of carbon and hydrogen alone, and heteroaromatic compound, which includes nitrogen or sulfur, and so on, in the condensed ring.

It is possible to produce the sulfur-based positive-electrode active material, which comprises a carbon skeleton being derived from pitches (ii), and sulfur being bonded to that carbon skeleton, by the following production process. That is, the production process is constituted so as to include a heat-treatment step in which a mixed raw material including pitches and sulfur is heated, and is further constituted so as to turn at least a part of the pitches and at least a part of the sulfur into a liquid in that heat-treatment step. In other words, at least a part of the pitches, and at least a part of the sulfur contact one another in the form of liquid in the heat-treatment step. Consequently, it is possible to make a contact area between the pitches and the sulfur larger sufficiently in the heat-treatment step, so that it is possible to obtain the sulfur-based positive-electrode active material that includes sulfur sufficiently, and in which the elimination of sulfur is inhibited. Note that, in a case where the sulfur is refluxed in the heat-treatment step, it is possible to enhance the contact frequency between the sulfur and the pitches, and thereby it is possible to obtain the sulfur-based positive-electrode active material that contains more sulfur, and in which the elimination of sulfur is inhibited furthermore.

Note that it is indefinite how sulfur and pitches are bonded one another in the obtained sulfur-based positive-electrode active material. However, it is presumed as follows: the sulfur is taken in between the graphene layers of pitches; or the sulfur substitutes for hydrogen being included in the rings of condensed polycyclic group, thereby making C—S bonds.

A temperature in the heat-treatment step can be such a temperature that at least a part of pitches, and at least a part of sulfur turn into a liquid. Note that, with regard to the pitches, it can preferably be such a temperature that the entirety turns into a liquid. Moreover, with regard to the sulfur, it is preferable that it can be such a temperature that the entirety turns into a liquid; and it is more preferable that some of it turns into a gas and the rest turns into a liquid (namely, a temperature that makes it possible to do refluxing). It is preferable that the temperature in the heat-treatment step can be 200° C. or more; it is more preferable that it can be 300° C. or more; and it is much more preferable that it can be 350° C. or more. For reference, the softening point of coal pitch is from 60 to 350° C. approximately. Thus, it is preferable to carry out the heat-treatment step at 350° C. or more in a case where coal pitch is used as the pitches. Moreover, when being 350° C. or more, at least a part of pitches softens (or turns into liquid) even in a case where pitches other than coal pitch are used.

Incidentally, when the temperature in the heat-treatment step is high excessively, there might possibly arise a case where pitches are modified (or graphitized). In this case, it becomes impossible to taken in sulfur into pitches sufficiently. Thus, it is preferable that the temperature in the heat-treatment step can be a temperature that is lower than the modification temperature of pitches. When the temperature in the heat-treatment step is 600° C. or less, it is possible to inhibit the modification of pitches. It is more preferable that the temperature in the heat-treatment step can be 600° C. or less; and it is much more preferable that it can be 500° C. or less. In addition, taking the above-described softening of pitches into consideration, it is preferable that the temperature in the heat-treatment step can be from 200° C. or more to 600° C. or less; it is more preferable that it can be from 300° C. or more to 500° C. or less; and it is much more preferable that it can be from 350° C. or more to 500° C. or less.

In a case where sulfur is refluxed in the heat-treatment step, it is allowable to heat the mixed raw material so that a part of the mixed raw material turns into a gas and the other part turns into a liquid. In other words, it is permissible that a temperature of the mixed raw material can be a temperature or more at which sulfur vaporizes. The “vaporization” as being referred to herein designates that sulfur undergoes phase change from the liquid or solid to the gas, and can result from any of the boiling, evaporation and sublimation. For reference, the melting point of α sulfur (or rhombic sulfur, being the most stable structure at around ordinary temperature) is 112.8° C.; the melting point of β sulfur (or monoclinic sulfur) is 119.6° C.; and the melting point of γ sulfur (or monoclinic sulfur) is 106.8° C. The boiling point of sulfur is 444.7° C. Incidentally, since the vapor pressure of sulfur is high, it is possible to ascertain the occurrence of sulfur vapor even visually when the temperature of the mixed raw material becomes 150° C. or more. Therefore, it is feasible to reflux sulfur when the temperature of the mixed raw material is 150° C. or more. Note that, in a case where sulfur is refluxed in the heat-treatment step, it is advisable to reflux sulfur using a reflux apparatus with known construction.

Note herein that, although it does not matter at all especially in what atmosphere the heat-treatment step is carried out, it is preferable to carry it out under such an atmosphere (e.g., an atmosphere that does not contain any hydrogen, or a nonoxidizing atmosphere) that does not discourage the bonding between pitches and sulfur. For example, when hydrogen exists in the atmosphere, a case might possibly arise where sulfur within a reaction system has been lost, because the sulfur within the reaction system reacts with hydrogen to turn into hydrogen sulfide. Moreover, the “nonoxidizing atmosphere” as being referred to herein involves the following: depressurized states whose oxide concentration is set at low to such an extent that oxidation reactions do not proceed; inert-gas atmospheres, such as nitrogen and argon; sulfur-gas atmospheres, and so on.

Configurations, particle diameters, and the like, of pitches and sulfur do not matter at all especially. Since pitches and sulfur are caused to contact one another in the form of liquid in the heat-treatment step, the pitches and sulfur contact one another sufficiently even in a case where the pitches' particle diameters are nonuniform or large, for instance. Moreover, although it is preferable that pitches and sulfur within the mixed raw material can be dispersed uniformly, they can be dispersed nonuniformly. It is also allowable that the mixed raw material can be constituted of pitches and sulfur alone, or it is even permissible to further compound a common material (e.g., an electrically-conductive additive, and the like) that is compoundable in positive-electrode active materials.

Since a heating time in the heat-treatment step can be set up properly in compliance with the heating temperature, it is not limited at all especially. In a case where doing heating at one of the above-mentioned preferable temperatures, however, it is preferable to do heating for from 10 minutes to 10 hours approximately; and it is more preferable to do heating for from 30 minutes to 6 hours.

A preferable range is present as to a compounding ratio as well between pitches and sulfur within the mixed raw material. This is because of the following: when a compounded amount of sulfur is too small with respect to that of pitches, the sulfur cannot be taken in into the pitches in a sufficient amount; whereas free sulfur (or sulfur elementary substance) has remained greatly within the sulfur-based positive-electrode active material to pollute, in particular, electrolytic solutions inside sodium secondary batteries when a compounded amount of sulfur is too much with respect to that of pitches. It is preferable that a compounding ratio between sulfur and pitches within the mixed raw material can be from 1:0.5 to 1:10 by mass ratio; it is more preferable that it can be from 1:1 to 1:7; and it is especially preferable that it can be from 1:2 to 1:5.

Note that, even in a case where a compounded amount of sulfur is too much with respect to that of pitches, it is possible to take in a sufficient amount of sulfur into pitches in the heat-treatment step. Consequently, in a case where sulfur is compounded excessively with respect to pitches, it is possible to inhibit the above-described adverse effect resulting from sulfur elementary substance by removing sulfur elementary substance from a post-heat-treatment-step processed body. To be concrete, in a case where a compounding ratio between carbonaceous material and sulfur is set at from 1:2 to 1:10 by mass ratio, it is possible to inhibit the above-described adverse effect resulting from remaining sulfur elementary substance while taking in a sufficient amount of sulfur into pitches by heating a post-heat-treatment-step processed body at from 200° C. to 250° C. while doing depressurizing (i.e., a sulfur-elementary-substance removal step). In a case where a post-heat-treatment-step processed body is not subjected to such a sulfur-elementary-substance removal step, it is allowable to use this processed body as the sulfur-based positive-electrode active material as it is. Moreover, in a case where a post-heat-treatment-step processed body is subjected to such a sulfur-elementary-substance removal step, it is permissible to use the resulting post-sulfur-elementary-substance-removal-step processed body as the sulfur-based positive-electrode active material.

When the sulfur-based positive-electrode active material being obtainable by means of the aforementioned production process undergoes Raman-spectrum analysis, it exhibits a Raman spectrum in which a major peak exists at around 1,557 cm⁻¹, one of the Raman shifts, and other peaks exist at around 1,371 cm⁻¹, 1,049 cm⁻¹, 994 cm⁻¹, 842 cm⁻¹, 612 cm⁻¹, 412 cm⁻¹, 354 cm⁻¹ and 314 cm⁻¹, the others of the Raman shifts, in a range of from 200 cm⁻¹ to 1,800 cm⁻¹, respectively. Note that the Raman spectrum of the sulfur-based positive-electrode active material, which comprises a carbon skeleton being derived from pitches (ii), and sulfur being bonded to that carbon skeleton, differs from the Raman spectrum of the sulfur-based positive-electrode active material, which comprises a carbon skeleton being derived from above-described “PAN” (i), and sulfur being bonded to that carbon skeleton.

As a result of subjecting this sulfur-based positive-electrode active material to elemental analysis, carbon, nitrogen, and sulfur were detected. Moreover, depending on cases, a small amount of oxygen and hydrogen was detected. Therefore, this sulfur-based positive-electrode active material contains, other than C and S, at least one member of nitrogen, oxygen, sulfuric compounds, and so on, as an impurity.

It is desirable that the sulfur-based positive-electrode active material, which comprises a carbon skeleton being derived from pitches (ii), and sulfur being bonded to that carbon skeleton, can further include a second sulfur-based positive-electrode active material, which comprises a second carbon skeleton being derived from “PAN” (i), and sulfur being bonded to the second carbon skeleton. Further including this second sulfur-based positive-electrode active material results in further upgrading the cyclability when being used as a positive electrode for sodium secondary battery. Although the reason for this has not been apparent yet, it is believed to be due to the fact that the bonding force between “PAN” and sulfur is so great that sulfur has been immobilized.

It is possible to produce the sulfur-based positive-electrode active material, which comprises a carbon skeleton being derived from polyisoprene (iii), and sulfur being bonded to that carbon skeleton, by carrying out a mixing step of mixing a raw material including polyisoprene and a sulfur powder to make a mixed raw material, and a heat-treatment step of heating the mixed raw material. In the mixing step, it is allowable to pulverize a polyisoprene dried substance and then mix it with a sulfur powder, or it is even permissible to mix a sulfur powder with a solution in which polyisoprene has been dissolved in a solvent. Alternatively, it is possible to mix latex or crude rubber, like natural rubber, with a sulfur powder. It is possible to use mixers, various types of mills, and the like, for mixing means.

In the heat-treatment step, polyisoprene, and sulfur are reacted with each other. Although this reaction is commonly called “vulcanization,” it is desirable to make a positive-electrode active material including sulfur in a high concentration by setting an amount of sulfur too much with respect to an amount of polyisoprene and then reacting them one another. As for a temperature in this heat-treatment step, it is desirable to carry out the reaction under such a condition that at least a part of polyisoprene, and at least a part of sulfur turn into a liquid. By thus doing, it is possible to make the contact area between polyisoprene and sulfur larger sufficiently, and accordingly it is possible to obtain the sulfur-based positive-electrode active material that includes sulfur sufficiently, and in which the elimination of sulfur is inhibited.

In the heat-treatment step, a case might possibly arise where a sulfur concentration within the reaction system becomes lower because sulfur vaporizes when setting the temperature too high. If such is the case, it is desirable to cause the reaction to take place while refluxing sulfur. By thus doing, it becomes likely to obtain the sulfur-based positive-electrode active material that includes sulfur sufficiently. In a case where sulfur is refluxed in the heat-treatment step, the temperature can be such a temperature or more that sulfur vaporizes, because the melting point of polyisoprene is as low as about 30° C.

Note that the vulcanization of common rubber materials is carried out in a temperature region of from 100° C. to 190° C. The vulcanization at around 120° C. is called “low-temperature vulcanization,” and the vulcanization from up around 180° C. is called “high-temperature over-vulcanization.” A temperature of the heat treatment being carried out in the present invention can be higher than the above-described temperature region; as for a heating temperature, it is preferable to set it at from 250° C. to 500° C., and it is preferable to set it at from 300° C. to 450° C. Moreover, it is possible to carryout setting up an atmosphere for the heat treatment in the same manner as the aforementioned specific instances for pitches.

As for polyisoprene, it is possible to use any of natural rubbers and synthetic polyisoprenes. However, cis-type polyisoprene is likely to form an irregular shape because the molecular chain takes on a zigzagged structure. Accordingly, many clearances occur between a molecular chain and the other molecular chain so that the intermolecular force becomes small relatively. Consequently, cis-type polyisoprene comes to have softer properties because no crystallization occurs between the molecules. Therefore, the cis-type is more preferable than the trans-type.

Configurations, particle diameters, and the like, of polyisoprene and sulfur in the mixed raw material do not matter at all especially. This is because it is preferable that polyisoprene and sulfur can contact one another in the form of liquid in the heat-treatment step. That is, it is because the polyisoprene and sulfur can contact one another sufficiently when setting up such a condition that the polyisoprene and sulfur can contact one another in the form of liquid, even in a case where the particle diameters of the polyisoprene and sulfur are nonuniform or large, for instance. Moreover, although it is preferable that polyisoprene and sulfur within the mixed raw material can be dispersed uniformly, they can be dispersed nonuniformly.

Since a heating time in the heat-treatment step can be set up properly in compliance with the heating temperature, it is not limited at all especially. In a case where heating the mixed raw material at one of the above-described preferable temperatures, however, it is preferable to do heating for from 1 minute to 10 hours approximately; and it is more preferable to do heating for from 5 minutes to 60 minutes. The vulcanizations of common rubber materials are carried out for from a few minutes to a few dozen minutes, depending on the heating temperatures. Such a vulcanization as being done for over 1 hour is called an “over-vulcanization,” and is deemed to lower performance as the resulting rubber per se. Since the sulfur-based positive-electrode active material being used in the present invention does not need to exhibit such a flexibility that has been required for rubber materials, it does not suffer from any problems even when a time for the heat treatment is made longer than the time for the so-called “over-vulcanization.”

In the aforementioned production process, a preferable range is present as to a compounding ratio as well between polyisoprene and sulfur within the mixed raw material. This is because of the following: when a compounded amount of sulfur is too small with respect to that of polyisoprene, the sulfur cannot be taken in into the polyisoprene in a sufficient amount; whereas free sulfur (or sulfur elementary substance) has remained greatly within the sulfur-based positive-electrode active material to pollute, in particular, electrolytic solutions inside sodium-ion secondary batteries when a compounded amount of sulfur is too much with respect to that of polyisoprene. It is preferable that a compounding ratio between polyisoprene and sulfur within the mixed raw material, namely, “Polyisoprene”:“Sulfur”, can be from 1:0.5 to 1:10 by mass ratio; it is more preferable that it can be from 1:1 to 1:7; and it is especially preferable that it can be from 1:2 to 1:5.

Note that, in the vulcanization treatment for common rubber in which natural rubber is the major raw material, the resulting rubber's stretch and shrinkage are altered by changing a proportion of sulfur to be added to the rubber. Elastic rubber (rubber band, for instance) generates when adding sulfur to chain-structured crude rubber in an amount of from about 3 to 6% and then doing heat treatment; whereas hard rubber (or ebonite, and the examples of its use are light-bulb socket and fountain pen) in a case where sulfur is from about 30 to 40%. The vulcanization of rubber has been usually carried out at a temperature of 140° C. approximately. In the present production process, however, the vulcanization is carried out at such a high temperature as from 250 to 500° C., so that substance with high S content (or sulfur-containing fraction) is obtainable, because of the following: the addition of S to the —C═C— double bonds occurs, thereby pulling out hydrogen atoms from —CH₂, and the like, within the polyisoprene structure so that the gas of hydrogen sulfide generates; and then the reaction takes place in which, instead of the pulled-out hydrogen atoms, S adds thereto.

When a compounded amount of sulfur is set too much with respect to that of polyisoprene, it is possible to take in a sufficient amount of sulfur into polyisoprene in the heat-treatment step. And, even when sulfur is compounded in a required amount or more with respect to polyisoprene, it is possible to inhibit the above-described adverse effect resulting from sulfur elementary substance by removing sulfur elementary substance from a post-heat-treatment-step processed body. To be concrete, in a case where a compounding ratio between polyisoprene and sulfur is set at from 1:2 to 1:10 by mass ratio, it is possible to inhibit the adverse effect resulting from remaining sulfur elementary substance while taking in a sufficient amount of sulfur into polyisoprene by heating a post-heat-treatment-step processed body at from 200° C. to 250° C. while doing depressurizing (i.e., a sulfur-elementary-substance removal step). In a case where a post-heat-treatment-step processed body is not subjected to such a sulfur-elementary-substance removal step, it is allowable to use this processed substance as the sulfur-based positive-electrode active material as it is. Moreover, in a case where a post-heat-treatment-step processed body is subjected to such a sulfur-elementary-substance removal step, it is permissible to use the resulting post-sulfur-elementary-substance-removal-step processed body as the sulfur-based positive-electrode active material.

It is also allowable that the mixed raw material can be constituted of polyisoprene and sulfur alone, or it is even permissible to further compound a common material (e.g., an electrically-conductive additive, and the like) that is compoundable in positive-electrode active materials.

In accordance with the aforementioned production process, it is possible to produce a positive-electrode active material for sodium secondary battery inexpensively, because it is feasible to procure the positive-electrode active material with ease relatively by compounding a substance that is made by reacting polyisoprene and sulfur one another, instead of compounding the rare metal, such as cobalt, as a material for the positive-electrode active material.

Moreover, natural rubber is a material that is not purified completely, and is inexpensive remarkably. Thus, in accordance with the aforementioned production process, it is possible to produce the sulfur-based positive-electrode active material inexpensively, even compared with the case where a carbonaceous material, such as “PAN,” is used, for instance. In general, although proteins, fatty acids, hydrocarbons, ashes, and so on, are included as non-rubber components in a summed amount of from 6 to 7% approximately in natural rubber, it is possible to obtain a material that functions as the sulfur-based positive-electrode active material, even in a case where materials like this are used.

Moreover, polyisoprene can be readily turned into the form of liquid by heating it. Thus, it is not at all necessary to take the particle diameters, and the like, of polyisoprene and sulfur into consideration especially, because the polyisoprene and sulfur contact with each other sufficiently in the heat-treatment step.

Although the sulfur-based positive-electrode active material, which comprises a carbon skeleton being derived from polyisoprene (iii) and sulfur being bonded to that carbon skeleton, has a structure like that of ebonite as expressed by Chemical Formula 1, for instance, that structure has not been apparent yet. However, it has a carbon skeleton being derived from polyisoprene, and exhibits an FT-IR spectrum in which major peaks exist at around 1,452 cm⁻¹, at around 1,336 cm⁻¹, at around 1,147 cm⁻¹, at around 1,067 cm⁻¹, at around 1,039 cm⁻¹, at around 938 cm⁻¹, at around 895 cm⁻¹, at around 840 cm⁻¹, at around 810 cm⁻¹ and at around 584 cm⁻¹, respectively.

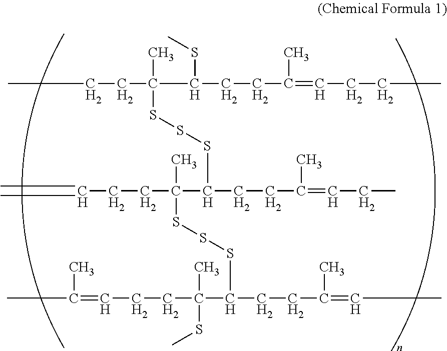

Meanwhile, polyisoprene exhibits an FT-IR spectrum in which major peaks exist at around 3,279 cm⁻¹, at around 3,034 cm⁻¹, at around 2,996 cm⁻¹, at around 2,931 cm⁻¹, at around 2,864 cm⁻¹, at around 2,728 cm⁻¹, at around 1,653 cm⁻¹, at around 1,463 cm⁻¹, at around 1,378 cm⁻¹, at around 834 cm⁻¹ and at around 579 cm⁻¹, respectively.

Moreover, a substance, which has been obtained by heat treating polyisoprene at 400° C., exhibits an FT-IR spectrum in which major peaks exist at around 2,962 cm⁻¹, at around 2,872 cm⁻¹, at around 2,723 cm⁻¹, at around 1,701 cm⁻¹, at around 1,458 cm⁻¹, at around 1,377 cm⁻¹, at around 968 cm⁻¹, at around 885 cm⁻¹ and at around 816 cm⁻¹, respectively.

In addition, common ebonite with about 30% sulfur containment exhibits an FT-IR spectrum in which major peaks exist at around 2,928 cm⁻¹, at around 2,858 cm⁻¹, at around 1,735 cm⁻¹, at around 1,643 cm⁻¹, at around 1,599 cm⁻¹, at around 1,518 cm⁻¹, at around 1,499 cm⁻¹, at around 1,462 cm⁻¹, at around 1,454 cm⁻¹, at around 1,447 cm⁻¹, at around 1,375 cm⁻¹, at around 1,310 cm⁻¹, at around 1,277 cm⁻¹, at around 1,2254 cm⁻¹, at around 1,194 cm⁻¹, at around 1,115 cm⁻¹, at around 1,088 cm⁻¹, at around 1,031 cm⁻¹, at around 953 cm⁻¹, at around 835 cm⁻¹, at around 739 cm⁻¹, at around 696 cm⁻¹, at around 654 cm⁻¹ and at around 592 cm⁻¹, respectively.

In an FT-IR spectrum, a region from 1,300 to 650 cm⁻¹ is called a fingerprint region, fine peaks can be found in a quantity of great numbers in that region, and their pattern comes to be one which is inherent to a substance. Therefore, it is feasible to identify what that substance is by cross-examining absorptions in this region with those of known samples or spectral data base. The FT-IR spectrum of the sulfur-based positive-electrode active material, which comprises a carbon skeleton being derived from polyisoprene (iii), and sulfur being bonded to that carbon skeleton, is completely different from that of the polyisoprene, that of the substance being obtained by heat treating the polyisoprene at 400° C., and that of the ebonite, so that it is feasible to identify the sulfur-based positive-electrode active material according to the present invention especially from the spectra in the above-described fingerprint region, and so on. In particular, since the peak at around 1,067 cm⁻¹, and the peak at around 895 cm⁻¹ are those which are appreciated only in the sulfur-based positive-electrode active material that comprises a carbon skeleton being derived from polyisoprene (iii) and sulfur bonded to that carbon skeleton, it is feasible to identify it by the FT-IR spectrum.

When subjecting the sulfur-based positive-electrode active material, which comprises a carbon skeleton being derived from polyisoprene (iii) and sulfur (S) being bonded to that carbon skeleton, to elemental analysis, sulfur (S) and carbon (C) account for the major part, and a small amount of oxygen and hydrogen is detected. It is desirable that sulfur (S) and carbon (C) can be included in a compositional ratio falling in a range of 1/5 or more by atomic ratio (e.g., S/C). If sulfur is less than this range, a case might possibly arise where the resulting charging and discharging characteristics decline when being used in a positive electrode for sodium secondary battery.

It is desirable that the sulfur-based positive-electrode active material, which comprises a carbon skeleton being derived from polyisoprene (iii), and sulfur being bonded to that carbon skeleton, can further include a second sulfur-based positive-electrode active material, which comprises a second carbon skeleton being derived from “PAN” (i), and sulfur being bonded to the second carbon skeleton. Further including this second sulfur-based positive-electrode active material results in further upgrading the cyclability when being used as a positive electrode for sodium secondary battery. Although the reason for this has not been apparent yet, it is believed to be due to the fact that the bonding force between “PAN” and sulfur is so great that sulfur has been immobilized.

In order to produce a positive-electrode active material further including this second sulfur-based positive-electrode active material, it is also possible to physically mix a first sulfur-based positive-electrode active material, which is formed by means of the reaction between polyisoprene and sulfur, with the second sulfur-based positive-electrode active material. However, since a case might possibly arise where the resulting stability is a concern, it is desirable in order to enhance the stability to carry out the following: a mixing step of mixing a raw material including polyisoprene, a “PAN” powder and a sulfur powder to make a mixed raw material; and a heat-treatment step of heating this mixed raw material. As for the “PAN” powder, those whose weight average molecular weight falls within a range of from 10,000 to 300,000 approximately are preferable. As to a particle diameter of “PAN”, those falling within a range of from 0.5 to 50 μm approximately are preferable; and those falling within a range of from 1 to 10 μm approximately are more preferable, upon observing it by means of electron microscope.

It is possible to set a compounding ratio at from 1:0.5 to 1:10 by mass ratio between a summed amount of polyisoprene and “PAN,” and sulfur within the mixed raw material. This is because of the following: when a compounded amount of sulfur is too small with respect to a summed amount of polyisoprene and “PAN,” the sulfur cannot be taken in into the polyisoprene and “PAN” in a sufficient amount; whereas free sulfur (or sulfur elementary substance) has remained greatly within the sulfur-based positive-electrode active material to pollute, in particular, electrolytic solutions inside sodium secondary batteries when a compounded amount of sulfur is too much with respect to a summed amount of polyisoprene and “PAN.” It is preferable that a compounding ratio of sulfur with respect to a summed amount of polyisoprene and “PAN” within the mixed raw material can be from 1:0.5 to 1:10 by mass ratio; it is more preferable that it can be from 1:1 to 1:7; and it is especially preferable that it can be from 1:2 to 1:5.

It is possible to carry out the heat-treatment step in a case where a “PAN” powder is further included within the mixed raw material in the same manner as the above-described production process in which “PAN” and sulfur are caused to react one another.

A mixed amount of the second sulfur-based positive-electrode active material is not restrictive at all especially. From the viewpoint of cost, however, it is preferable to set it at from 0 to 80% by mass approximately; it is more preferable to set it at from 5 to 60% by mass approximately; and it is much more preferable to set it at from 10 to 40% by mass approximately, to the entire positive-electrode active material.

A polycyclic aromatic hydrocarbon (or “PAH”) (iv) that is made by condensing six-membered rings in a quantity of three rings or more is a general term for hydrocarbons in which aromatic rings free from any hetero atom and substituent group are condensed. Those which comprise four-membered rings, five-membered rings, six-membered rings and seven-membered rings are available. Of these, however, it is preferable for the present invention to use sulfur and at least one member of the following: acenes possessing a structure in which six-membered rings, the benzene-ring structure, lie one after another in a straight-chained manner in a quantity of three rings or more; and compounds possessing a structure in which six-membered rings are disposed not in a straight-chained manner but in a zigzagged manner in a quantity of three rings or more.

As for the acenes, namely, polycyclic aromatic hydrocarbons in which a plurality of aromatic rings lie one after another in a straight-chained manner while sharing one of the sides, the following are available: naphthalene with two rings: anthracene with three rings; tetracene with four rings; pentacene with five rings; hexacene with six rings; heptacene with seven rings; octacene with eight rings; nonacene with nine rings; and those in which aromatic rings line one after another in a quantity of ten rings or more. It is possible to use at least one member being selected from the group consisting of those above. Among them, those with from three rings to six rings whose stability is higher are desirable.

Moreover, as for the polycyclic aromatic hydrocarbon possessing a structure that has six-membered rings being disposed not in a straight-chained manner but in a zigzagged manner in a quantity of three rings or more, the following are available: phenanthrene, benzopyrene, chrysene, pyrene, picene, perylene, triphenylene, coronene, and those in which aromatic rings lie one after another in a quantity that is more than the quantities of rings in those foregoing options. It is possible to use at least one member being selected from the group consisting of those above.

In order to produce the sulfur-based positive-electrode active material comprising: a carbon skeleton being derived from a polycyclic aromatic hydrocarbon (iv) that is made by condensing six-membered rings in a quantity of three rings or more; and sulfur being bonded to that carbon skeleton, it is possible to carry out the production in the same manner as the instances where it comprises pitches or polyisoprene.

In the heat-treatment step, the polycyclic aromatic hydrocarbon, and sulfur are caused to react one another. It is desirable to make a positive-electrode active material including sulfur in a high concentration by setting an amount of sulfur too much with respect to an amount of the polycyclic aromatic hydrocarbon and then reacting them one another. As for a temperature in this heat-treatment step, it is desirable to carry out the reaction under such a condition that at least a part of the polycyclic aromatic hydrocarbon, and at least a part of sulfur turn into a liquid. By thus doing, it is possible to make the contact area between the polycyclic aromatic hydrocarbon and sulfur larger sufficiently, and accordingly it is possible to obtain the sulfur-based positive-electrode active material that includes sulfur sufficiently, and in which the elimination of sulfur is inhibited.

A preferable range is present as to a compounding ratio as well between the polycyclic aromatic hydrocarbon and sulfur within the mixed raw material. This is because of the following: when a compounded amount of sulfur is too small with respect to that of the polycyclic aromatic hydrocarbon, the sulfur cannot be taken in into the polycyclic aromatic hydrocarbon in a sufficient amount; whereas free sulfur (or sulfur elementary substance) has remained greatly within the sulfur-based positive-electrode active material to pollute, in particular, electrolytic solutions inside sodium secondary batteries when a compounded amount of sulfur is too much with respect to that of the polycyclic aromatic hydrocarbon. It is preferable that a compounding ratio between the polycyclic aromatic hydrocarbon and sulfur within the mixed raw material, namely, “Polycyclic Aromatic Hydrocarbon”:“Sulfur”, can be from 1:0.5 to 1:10 by mass ratio; it is more preferable that it can be from 1:1 to 1:7; and it is especially preferable that it can be from 1:2 to 1:5.

Note that, when a compounded amount of sulfur is set too much with respect to that of the polycyclic aromatic hydrocarbon, it is possible to taken in a sufficient amount of sulfur into the polycyclic aromatic hydrocarbon in the heat-treatment step. And, even when sulfur is compounded in a required amount or more with respect to the polycyclic aromatic hydrocarbon, it is possible to inhibit the above-described adverse effect resulting from sulfur elementary substance by carrying out a sulfur-elementary-substance removal step of removing the excessive sulfur elementary substance from a post-heat-treatment-step processed body. To be concrete, in a case where a compounding ratio between the polycyclic aromatic hydrocarbon and sulfur is set at from 1:2 to 1:10 by mass ratio, it is possible to inhibit the adverse effect resulting from remaining sulfur elementary substance while taking in a sufficient amount of sulfur into the polycyclic aromatic hydrocarbon by heating a post-heat-treatment-step processed body at from 200° C. to 250° C. while doing depressurizing (i.e., a sulfur-elementary-substance removal step). In a case where a post-heat-treatment-step processed body is not subjected to such a sulfur-elementary-substance removal step, it is allowable to use this processed substance as the sulfur-based positive-electrode active material as it is. Moreover, in a case where a post-heat-treatment-step processed body is subjected to such a sulfur-elementary-substance removal step, it is permissible to use the resulting post-sulfur-elementary-substance-removal-step processed body as the sulfur-based positive-electrode active material.

It is also allowable that the mixed raw material can be constituted of the polycyclic aromatic hydrocarbon and sulfur alone, or it is even permissible to further compound a common material (e.g., an electrically-conductive additive, and the like) that is compoundable in positive-electrode active materials.

It is believed that the sulfur-based positive-electrode active material, which comprises a carbon skeleton being derived from a compound being selected from the polycyclic aromatic hydrocarbons (iv) that are made by condensing six-membered rings in a quantity of 3 rings or more, and sulfur bonded to the carbon skeleton, comes to have a structure, which is similar to that of hexathiapentacene as being expressed by Chemical Formula 2, in a case where pentacene is chosen as the polycyclic aromatic hydrocarbon, one of the starting materials, for instance. However, its structure has not been apparent yet. Moreover, the sulfur-based positive-electrode active material, in which anthracene is used as the polycyclic aromatic hydrocarbon, exhibits an FT-IR spectrum in which peaks exist at around 1,056 cm⁻¹ and at around 840 cm⁻¹, respectively. Since the FT-IR spectrum is completely different from an FT-IR spectrum of anthracene, it is possible to identify it by the FT-IR spectrum.

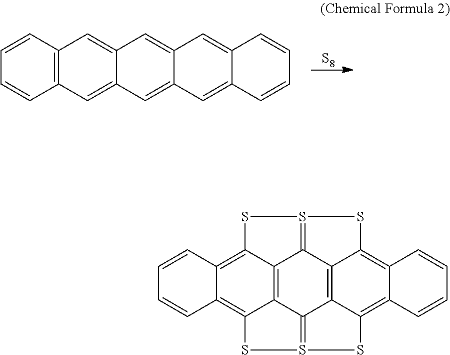

When subjecting the sulfur-based positive-electrode active material, which comprises a carbon skeleton being derived from a compound that is selected from the polycyclic aromatic hydrocarbons (iv) being made by condensing six-membered rings in a quantity of 3 rings or more, and sulfur (S) being bonded to the carbon skeleton, to elemental analysis, sulfur (S) and carbon (C) account for the major part, and a small amount of oxygen and hydrogen is detected. It is desirable that sulfur (S) and carbon (C) can be included in a compositional ratio falling in a range of 1/5 or more by atomic ratio (e.g., S/C). If sulfur is less than this range, a case might possibly arise where the resulting charging and discharging characteristics decline when being used in a positive electrode for sodium secondary battery.

It is desirable that the sulfur-based positive-electrode active material, which comprises a carbon skeleton being derived from a compound that is selected from the polycyclic aromatic hydrocarbons (iv) being made by condensing six-membered rings in a quantity of 3 rings or more, and sulfur (S) being bonded to the carbon skeleton, can further include a second sulfur-based positive-electrode active material, which comprises a second carbon skeleton being derived from “PAN” (i), and sulfur being bonded to the second carbon skeleton, in the same manner as the above-described instance where polyisoprene is used. Its mixed amount, production process and so on are the same as those in the instance where polyisoprene is used.

### Positive Electrode for Sodium Secondary Battery

A positive electrode being used in the sodium secondary according to the present invention includes one of the above-described sulfur-based positive-electrode active materials. Except for the positive-electrode active material, it is possible for this positive electrode for sodium secondary battery to have the same construction as that of a common positive electrode for sodium secondary battery. For example, it is possible to manufacture the positive electrode by means of applying a positive-electrode material, in which one of the aforementioned sulfur-based positive-electrode active materials, an electrically-conductive additive, a binder and a solvent are mixed, onto a current collector.

As for an electrically-conductive additive, the following can be exemplified: gas-phase-method carbon fibers (or vapor grown carbon fibers (or VGCF)), carbon powders, carbon black (or CB), acetylene black (or AB), KETJENBLACK (or KB), graphite, fine powders of metals being stable at positive-electrode potentials, such as aluminum and titanium, and the like. Note that, depending on the constitution of a later-described conductor, a case might possibly arise as well where it is even advisable not to compound any electrically-conductive additive.

As for a binder, the following can be exemplified: polyvinylidene fluoride (e.g., PolyVinylidene DiFluoride (or PVDF)), polytetrafluoroethylene (or PTFE), styrene-butadiene rubber (or SBR), polyimide (or PI), polyamide-imide (or PAI), carboxymethyl cellulose (or CMC), polyvinyl chloride (or PVC), methacryl resins (or PMA), polyacrylonitrile (or PAN), modified polyphenylene oxide (or PPO), polyethylene oxide (or PEO), polyethylene (or PE), polypropylene (or PP), and the like.

As for a solvent, the following can be exemplified: N-methyl-2-pyrrolidone, N,N-dimethylformaldehyde, alcohols, water, and the like. These electrically-conductive additives, binders and solvents can be mixed in a plurality of species, respectively, to use. Although compounding amounts of these materials do not at all matter especially, it is preferable to compound an electrically-conductive additive in an amount of from 20 to 100 parts by mass approximately, and a binder in an amount of from 10 to 20 parts by mass approximately, for instance, with respect to 100 parts by mass of the sulfur-based positive-electrode active material. Moreover, as another method, it is also possible to fabricate the positive electrode for sodium secondary battery by kneading and forming a mixed raw material of one of the sulfur-based positive-electrode active materials and the above-described electrically-conductive additive and binder as a film shape with mortar or pressing machine, and the like, and then press attaching the resulting film-shaped mixed raw material onto a current collector with pressing machine, and so on.

As for a current collector, it is advisable to employ those which have been used commonly in positive electrodes for sodium secondary battery. For example, as for a current collector, the following can be exemplified: aluminum foils, aluminum meshes, punched aluminum sheets, aluminum expanded sheets, stainless-steel foils, stainless-steel meshes, punched stainless-steel sheets, stainless-steel expanded sheets, foamed nickel, nickel nonwoven fabrics, copper foils, copper meshes, punched copper sheets, copper expanded sheets, titanium foils, titanium meshes, carbon nonwoven fabrics, carbon woven fabrics, carbon papers, and the like. Of these, a carbon nonwoven fabric/woven fabric current collector, which comprises carbon with high graphitization degree, is suitable for a current collector for the sulfur-based positive-electrode active materials, because it does not include any hydrogen and the reactivity to sulfur is low. As for a raw material for carbon fiber with high graphitization degree, it is possible to use various types of pitches (namely, the byproducts of petroleum, coal, coal tar, and so on) that make a material for carbon fibers, or PAN fibers, and so forth.

The positive electrode for sodium secondary battery according to the present invention includes one of the above-described sulfur-based positive-electrode active materials as a positive-electrode active material. Therefore, a sodium secondary battery using that positive electrode exhibits large charging and discharging capacities and are excellent in terms of the cyclability, and can be manufactured inexpensively.

It is desirable that the positive electrode including one of the above-described sulfur-based positive-electrode active materials can further include a conductor comprising sulfide of at least one member of metals that is selected from the group consisting of fourth-period metals, fifth-period metals, sixth-period metals, and rare-earth elements. The sulfides of these metals show of themselves high electric conductivity (or electroconductivity); alternatively are capable of causing the sodium-ion conductivity of the positive electrode to upgrade. Consequently, the sulfides of these metals function as a conductor, respectively. And, compounding the sulfides of these metals leads to enabling the resulting discharging rate characteristic to upgrade.

Note that, since a conductor is compounded in the positive electrode along with one of the above-described sulfur-based positive-electrode active materials, such a case might possibly arise that it is sulfurized by means of sulfur being included in the sulfur-based positive-electrode active material at the time of manufacturing the positive electrode and/or at the time of charging and discharging the resulting battery. Thus, such a problem might possibly occur that it is less likely to cause the resultant discharging rate characteristic to upgrade, in a case where a material whose electric conductivity is low in the form of sulfide, or a material that is not capable of causing the sodium-ion conductivity to upgrade, is used as a conductor. However, in the present invention, a conductor enables the resulting discharging rate characteristic to upgrade, because one of those which show high electric conductivity in the form of sulfide, or which are capable of causing the sodium-ion conductivity of the positive electrode to upgrade, is used as a conductor.

Note that the fourth-period metals, fifth-period metals and sixth-period metals being referred to in the present description are those which are based on the periodic table of elements. For example, the fourth-period metals designate metals being involved in the fourth-period elements in the periodic table. As for a material for the conductor, those which exhibit of themselves high electric conducting property in the form of sulfide are preferable; alternatively those which are capable of causing the sodium-ion conducting property of positive electrode to upgrade greatly. For example, the conductor can be at least one member being selected from the group consisting of Ti, La, Ce, Pr, Nd, Sm, V, Mn, Fe, Ni, Cu, Zn, Mo, Ag, Cd, In, Sn, Sb, Ta, W and Pb, or their sulfides (such as La₂S₃, TiS₂, Sm₂S₃, Ce₂S₃ and MoS₂, for instance). Note that, within the positive electrode, the conductor can comprise both species, namely, one of the aforementioned metals as well as its sulfide; alternatively it can comprise one of the aforementioned metals' sulfide alone. It is preferable that these materials for the conductor can include one of the sulfides much more; and it is much more preferable that they can comprise one of the sulfides alone. This is because compounding the aforementioned metals in the positive electrode in the form of sulfide makes the conductor and the sulfur-based positive-electrode active materials likely to familiarize with each other and thereby the conductor and the sulfur-based positive-electrode active materials disperse one another substantially uniformly. Moreover, using the sulfides as a material for the conductor has also an advantage of making it possible to control a proportion of the aforementioned metals to sulfur in the conductor within a desirable range with ease.

To be concrete, as for a conductor with high electric conductively and/or sodium-ion conducting property, the following can be given: TiS₂, FeS₂, Me₂S₃ (where “Me” is at least one member being selected from Ti, La, Ce, Pr, Nd and Sm in the formula), MeS (where “Me” is at least one member being selected from Ti, La, Ce, Pr, Nd and Sm in the formula), Me₃S₄ (where “Me” is at least one member being selected from Ti, La, Ce, Pr, Nd and Sm in the formula), and MeS (where “Me” is at least one member being selected from Ti, V, Mn, Fe, Ni, Cu, Zn, Mo, Ag, Cd, In, Sn, Sb, Ta, W, and Pb; and “x” and “y” are arbitrary integers in the formula). In this instance, as for a material for the conductor, it is allowable to use at least one member being selected from Ti, La, Ce, Pr, Nd, Sm, V, Mn, Fe, Ni, Cu, Zn, Mo, Ag, Cd, In, Sn, Sb, Ta, W and Pb as it is, or it is permissible to use it in the form of sulfide in the same manner as the aforementioned conductor. Using one of these materials the conductor results in causing the electric conductivity and/or sodium-ion conducting property of the entire positive electrode to upgrade, thereby enabling the discharging rate characteristic of the resulting sodium secondary battery to upgrade. Note that, in view of raw-material cost and procurement readiness or resource amount, it is more preferable to use TiS_{z} (where “z” is from 0.1 to 2 in the formula), and it is especially preferable to use TiS₂.

It is preferable that a compounding ratio between the sulfur-based positive-electrode active material, which comprises a carbon skeleton being derived from a carbon-source compound that is selected from a group consisting of “PAN”, pitches, polyisoprene and a polycyclic aromatic hydrocarbon that is made by condensing six-membered rings in a quantity of three rings or more, and sulfur (S) being bonded to the carbon skeleton, and a conductor can be from 10:0.5 to 10:5 by mass ratio; and it is more preferable that it can be from 10:1 to 10:3. This is because of the following: an amount of the positive-electrode active material becomes too small with respect to the entire positive electrode when a compounding amount of the conductor is too much. In order to cause the conductor to disperse substantially uniformly within the sulfur-based positive-electrode active material, it is preferable that the conductor can have a powdery shape. It is preferable that the conductor can have a particle diameter of from 0.1 to 100 μm that is measured with use of electron microscope, and so on; it is more preferable that it can have a particle diameter of from 0.1 to 50 μm; and it is much more preferable that it can have a particle diameter of from 0.1 to 20 μm.

Note that, in order to identify the mixing of one of the sulfur-based positive-electrode active materials with a conductor, it is possible to carry out the identification by means of X-ray diffraction analysis as follows.

Major diffraction peak positions of La₂S₃ according to the ASTM card are 24.7, 25.1, 26.9, 33.5, 37.2, 42.8 degrees, and so on. Major diffraction peak positions of TiS₂ are 15.5, 34.2, 44.1, 53.9 degrees, and so on. Major diffraction peak positions of Ti are 35.1, 38.4, 40.2, 53.0 degrees, and so on. Major diffraction peak positions of MoS₂ are 14.4, 32.7, 33.5, 35.9, 39.6, 44.2, 49.8, 56.0, 58.4 degrees, and so on. Major diffraction peak positions of Fe are 44.7, 65.0, 82.3 degrees, and so on. In the sulfur-based positive-electrode active material in which “PAN” was used, a broad single peak was appreciable at around 25 degrees in a range where the diffraction angle (2θ) was from 20 to 30 degrees. On the contrary, in a sulfur-based positive-electrode active material/conductor composite body in which a conductor was used, a peaks being derived from the conductive member appeared. For example, in a case where La₂S₃ was used as a material for the conductor, the peaks of La₂S₃ appeared at around 24.7, 25.1, 33.5 and 37.2 degrees. By means of these peaks, it is possible to ascertain that La₂S₃ has been used as a material for the conductor (that is, the positive electrode includes La₂S₃ as a conductor). Moreover, in a case where TiS₂ was used as a material for the conductor, such peaks could hardly be ascertained. In a case where Ti was used as a material for the conductor, the peaks of Ti appeared at around 35.1, 38.4, 40.2 and 53.0 degrees. By means of these peaks, it is possible to ascertain that Ti has been used as a material for the conductor. As being aforementioned, in a case where TiS₂ was used as a material for the conductor, it was impossible to ascertain the existence by X-ray diffraction; however, since it is possible to detect Ti when using another method of analysis, namely, methods such as ICP elemental analysis and fluorescent X-ray analysis, for instance, it is possible to presume the addition of TiS₂ even in a case where no peak can be ascertained by X-ray diffraction. Moreover, in a case where MoS₂ was used as a material for the conductor, the peaks of MoS₂ appeared at around 14.4, 32.7, 33.5, 35.9, 39.6, 44.2, 49.8, 56.0 and 58.4 degrees. By means of these peaks, it is possible to ascertain that MoS₂ has been used as a material for the conductor (that is, the positive electrode includes MoS₂ as a conductive member). In a case where Fe was used as a material for the conductor, the peaks of FeS₂ appeared at around 28.5, 33.0, 37.1, 40.8, 47.4, 56.3 and 59.0 degrees. By means of these peaks, it is possible to ascertain that Fe has been used as a material for the conductor (that is, the positive electrode includes at least one species of FeS, FeS₂ and Fe₂S₃ as a conductor).

### Sodium Secondary Battery

Hereinafter, a constitution of a sodium secondary battery in which one of the above-described sulfur-based positive-electrode active materials is used for the positive electrode. With regard to the positive electrode, it is the same as having been described above.

### Negative Electrode

As for a negative-electrode material, it is possible to employ publicly-known metallic sodium, carbon-based materials such as non-graphitizable carbon (or hard carbon), alloy materials being capable of occluding (or sorbing) and releasing (or desorbing) sodium ion, and the like. In a case where a material free from sodium is employed as a negative-electrode material, for example, in a case where, of the aforementioned negative-electrode materials, a carbon-based material, a tin-based material or another alloy-based material, and so on, is used, it is advantageous in that the short-circuiting between positive and negative electrodes, which results from the occurrence of dendrite, is less likely to arise. However, in a case where these negative-electrode materials free from sodium are combined with the positive electrode according to the present invention to use, neither the positive electrode nor the negative electrode includes sodium at all. Thus, a sodium-pre-doping treatment, in which sodium is inserted into either one of the negative electrode and positive electrode, or into both of them, becomes necessary. Since a pre-doping method of sodium is the same as a pre-doping method of lithium, it can be carried out in a manner that conforms to publicly-known pre-doping methods of lithium. For example, in a case a negative electrode is doped with sodium, the following methods can be given: a method of assembling a half-cell using metallic sodium as the counter electrode and then inserting sodium into it by means of electrolytically-doping method of doping it with sodium electrochemically; and a method of inserting sodium by means of application pre-doping method, in which, while utilizing the diffusion of sodium into an electrode, doping is done after applying a metallic sodium foil onto the electrode and then leaving the electrode with the metallic sodium foil applied as it is within an electrolytic solution. Moreover, in another case as well where the positive electrode is pre-doped with sodium, it is possible to utilize the aforementioned electrolytically-doping method.

As for a current collector for the negative electrode, the following can be exemplified: aluminum foils, aluminum meshes, punched aluminum sheets, aluminum expanded sheets, stainless-steel foils, stainless-steel meshes, punched stainless-steel sheets, stainless-steel expanded sheets, foamed nickel, nickel nonwoven fabrics, copper foils, copper meshes, punched copper sheets, copper expanded sheets, titanium foils, titanium meshes, carbon nonwoven fabrics, carbon woven fabrics, carbon papers, and the like. Of these, a woven fabric or nonwoven fabric, which is made from hard carbon, is preferable. This is because hard carbon has larger spaces between the layers than does graphite, so that it becomes easier for sodium ions, which are more bulky than are lithium ions, to go out and come in the spaces.

### Electrolyte

As for an electrolyte to be used in the sodium secondary battery, it is possible to use those in which an alkali-metal salt serving as an electrolyte has been dissolved in an organic solvent. As for an organic solvent, it is preferable to use at least one member being selected from nonaqueous solvents, such as ethylene carbonate, propylene carbonate, dimethyl carbonate, diethyl carbonate, ethyl methyl carbonate, isopropyl methyl carbonate, vinylene carbonate, dimethyl ether, γ-butyrolactone and acetonirile. As for an electrolyte, it is possible to use at least one member, or a plurality of members, being selected from NaPF₆, NaBF₄, NaClO₄, NaAsF₆, NaSbF₆, NaCF₃SO₃, NaN(SO₂CF₃)₂, sodium salts of lower fatty acids, NaAlCl₄, and the like. Among them, it is preferable to use one or more members being selected from the group consisting of NaPF₆, NaBF₄, NaAsF₆, NaSbF₆, NaCF₃SO₃ and NaN(SO₂CF₃)₂ that include fluorine (F). A concentration of the electrolyte can be from 0.5 mol/L to 1.7 mol/L approximately. Note that the electrolyte is not at all limited to the form of liquid. For example, in a case where the sodium secondary battery is a sodium polymer secondary battery, the electrolyte makes the form of solid (or the form of polymer gel, for instance).

### Others

In addition to the above-described negative electrode, positive electrode and electrolyte, the sodium secondary battery can be further equipped with the other members, such as separators, as well. A separator intervenes between the positive electrode and the negative electrode, thereby not only allowing the movements of ions between the positive electrode and the negative electrode but also preventing the positive electrode and the negative electrode from internally short-circuiting one another. When the sodium secondary battery is a hermetically-closed type, a function of retaining the electrolytic solution is required for the separator. As for a separator, it is preferable to use a thin-thickness and microporous or nonwoven-shaped film that is made from a material, such as polyethylene, polypropylene, polyacrylonitrile, aramide, polyimide, cellulose or glass, and the like. A configuration of the sodium secondary battery is not limited at all especially, and can be formed as a variety of configurations, such as cylindrical types, laminated types or coin types, and so on.

Hereinafter, a production process for sulfur-based positive-electrode active material, the resulting sulfur-based positive-electrode active material, and the resultant sodium secondary battery will be explained in detail.

### EXAMPLES

### Example No. 1

### (1) Mixed Raw Material

As a sulfur powder, one which came to have particle diameters of 50 μm or less upon classifying it using a sieve was prepared. As a “PAN” powder, one whose particle diameters fell in a range of from 0.2 μm to 2 μm in a case where they were ascertained by an electron microscope was prepared. Five parts by mass of the sulfur powder, and one part by mass of the “PAN” powder were pulverized and/or mixed with each other in a mortar, thereby obtaining a mixed raw material.

### (2) Apparatus

As illustrated in FIG. 3, a reaction apparatus 1 had a reaction container 2; a lid 3; a thermocouple 4; an alumina protective tube 40; two alumina tubes (i.e., a gas introduction tube 5, and a gas discharge tube 6); argon-gas piping 50; a gas tank 51 in which an argon gas was accommodated; trap piping 60; a trapping bath 62 in which a sodium hydroxide aqueous solution 61 was accommodated; an electric furnace 7; and a temperature controller 70 being connected with the electric furnace.

As for the reaction container 2, a glass tube being made of quartz glass that was formed as a bottomed cylindrical shape was used. In a later-described heat-treatment step, a mixed raw material 9 was accommodated in the reaction container 2. An opening of the reaction container 2 was closed with the lid 3 being made of glass that possessed three through holes. One of the three through holes was furnished with the alumina protective tube 40 (e.g., “Alumina SSA-S,” a product of NIKKATO Co., Ltd.) in which the thermocouple 4 was accommodated. The other one of the through holes was furnished with the gas introduction tube 5 (e.g., “Alumina SSA-S,” a product of NIKKATO Co., Ltd.). The other remaining one of the through holes was furnished with the gas discharge tube 6 (e.g., “Alumina SSA-S,” a product of NIKKATO Co., Ltd.). Note that the reaction container 2 had 60 mm in outside diameter, 50 mm in inside diameter, and 300 mm in length. The alumina protective tube 40 had 4 mm in outside diameter, 2 mm in inside diameter, and 250 mm in length. The gas introduction tube 5 and gas discharge tube 6 had 6 mm in outside diameter, 4 mm in inside diameter, and 150 mm in length, respectively. The leading ends of the gas introduction tube 5 and gas discharge tube 6 were exposed to outside the lid 3 (namely, inside the reaction container 2). These exposed portions had a length of 3 mm. The leading ends of the gas introduction tube 5 and gas discharge tube 6 became nearly 100° C. or less in a later-described heat-treatment step. Hence, sulfur vapors occurring in the heat-treatment step did not flow out through the gas introduction tube 5 and gas discharge tube 6, but were returned back (or refluxed) to the reaction container 2.

The leading end of the thermocouple 4, which was put in the alumina protective tube 40, measured indirectly temperatures of the mixed raw material 9 inside the reaction container 2. The temperatures being measured with the thermocouple 4 were fed back to the temperature controller 70 for the electric furnace 7.

The gas introduction tube 5 was connected with the argon-gas piping 50. The argon-gas piping 50 was connected with the gas tank 51 in which an argon gas was accommodated. The gas discharge tube 6 was connected with one of the opposite ends of the trap piping 60. The other one of the opposite ends of the trap piping 60 was inserted into the sodium hydroxide aqueous solution 61 inside the trapping bath 62. Note that the trap piping 60 and trapping bath 62 are a trap for hydrogen sulfide gases occurring in a later-described heat-treatment step.

### (3) Heat-Treatment Step

The reaction container 2 accommodating the mixed raw material 9 therein was accommodated in the electric furnace 7 (e.g., a crucible furnace whose opening width was φ80 mm and heating height was 100 mm). On this occasion, argon was introduced into the interior of the reaction container 2 by way of the gas introduction tube 5. A flow rate of the argon gas on this occasion was 100 mL/min. 10 minutes after starting introducing the argon gas, heating of the mixed raw material 9 inside the reaction container 2 was started while continuing the introduction of the argon gas. A temperature increment rate on this occasion was 5° C./min. At a point of time when the mixed raw material 9 became 100° C., the introduction of the argon gas was stopped while continuing the heating of the mixed raw material 9. When the mixed raw material 9 became about 200° C., gases generated. At another point of time when the mixed raw material 9 became 360° C., the heating was stopped. After stopping the heating, the temperature of the mixed raw material 9 rose up to 400° C., and then declined thereafter. Therefore, in this heat-treatment step, the mixed raw material 9 was heated up to 400° C. Thereafter, the mixed raw material 9 was cooled naturally, and a product (that is, a post-heat-treatment-step processed body) was taken out from the reaction container 2 at still another point of time when the mixed raw material 9 was cooled down to room temperature (i.e., about 25° C.). Note that the heating time on this occasion was for about five minutes at 400° C., so that sulfur was refluxed.

### (4) Sulfur-Elementary-Substance Removal Step

In order to remove sulfur elementary substances (or free sulfur) remaining in the post-heat-treatment-step processed body, the following step was carried out.

The post-heat-treatment-step processed body was pulverized in a mortar. The pulverized substance was put in a glass tube in an amount of 2 grams, and was then heated at 200° C. for 3 hours while doing vacuum suctioning. A temperature increment rate on this occasion was 10° C./min. By means of this step, sulfur elementary substances, which were remaining in the post-heat-treatment-step processed body, were evaporated and were then removed, thereby obtaining a sulfur-based positive-electrode active material according to Example No. 1 being free from sulfur elementary substances (or including sulfur elementary substances in a trace amount).

A Raman analysis was carried out for this sulfur-based positive-electrode active material using “RMP-320,” a product of JASCO Corporation, whose excitation wavelength λ was 532 nm, grating was 800 gr/mm, and resolution was 3 cm⁻¹. The obtained Raman spectrum is shown in FIG. 2. In FIG. 2, the horizontal axis is the Raman shifts, and the vertical axis is the relative intensities. As can be understood from FIG. 2, a major peak existed at around 1,327 cm⁻¹, and the other peaks existed at around 1,556 cm₋₁, 945 cm⁻¹, 482 cm⁻¹, 381 cm⁻¹ and 320 cm⁻¹, respectively, in a range of from 200 cm⁻¹ to 1,800 cm⁻¹, according to the results of the Raman analysis.

### Manufacture of Sodium-Ion Secondary Battery

### (1) Positive Electrode

A mixed raw material, which comprised the above-described sulfur-based positive-electrode active material in an amount of 3 parts by mass, acetylene black (or AB) in an amount of 2.7 parts by mass and polytetrafluoroethylene (or PTFE) in an amount of 0.3 parts by mass, was kneaded in a mortar being made of agate until it turned into a film shape while adding hexane to it in a proper amount, thereby obtaining a film-shaped positive-electrode material. This positive-electrode material was press attached in the entire amount by a pressing machine onto an aluminum mesh with #100 in mesh roughness that had been punched out to a circle with 11 mm in diameter, and was dried thereon at 80° C. overnight, thereby obtaining a positive electrode according to Example No. 1 for sodium-ion secondary battery.

### (2) Negative Electrode

For a negative electrode, a disk-shaped sodium foil was used which was formed to about 0.5 mm in thickness and about φ13 mm in diameter by slicing metallic sodium.

### (3) Electrolytic Solution

As for an electrolytic solution, a nonaqueous electrolytic solution was used in which NaClO₄ had been dissolved in propylene carbonate. The concentration of NaClO₄ was 1.0 mol/L within the electrolytic solution.

### (4) Battery

Using the positive electrode, negative electrode and electrolytic solution obtained in (1), (2) and (3) above, a coin battery was manufactured. To be concrete, within a dry room, a glass nonwoven filter with 500 μm in thickness was held or sandwiched between the positive electrode and the negative electrode, thereby making an electrode-assembly battery. This electrode-assembly battery was accommodated in a battery case (e.g., a member for CR2032-type coin battery, a product of HOSEN Co., Ltd.) comprising a stainless-steel container. The electrolytic solution obtained in (3) above was then injected into the battery case. The battery case was sealed hermetically by a crimping machine, thereby obtaining a sodium secondary battery according to Example No. 1.

### Charging/Discharging Test

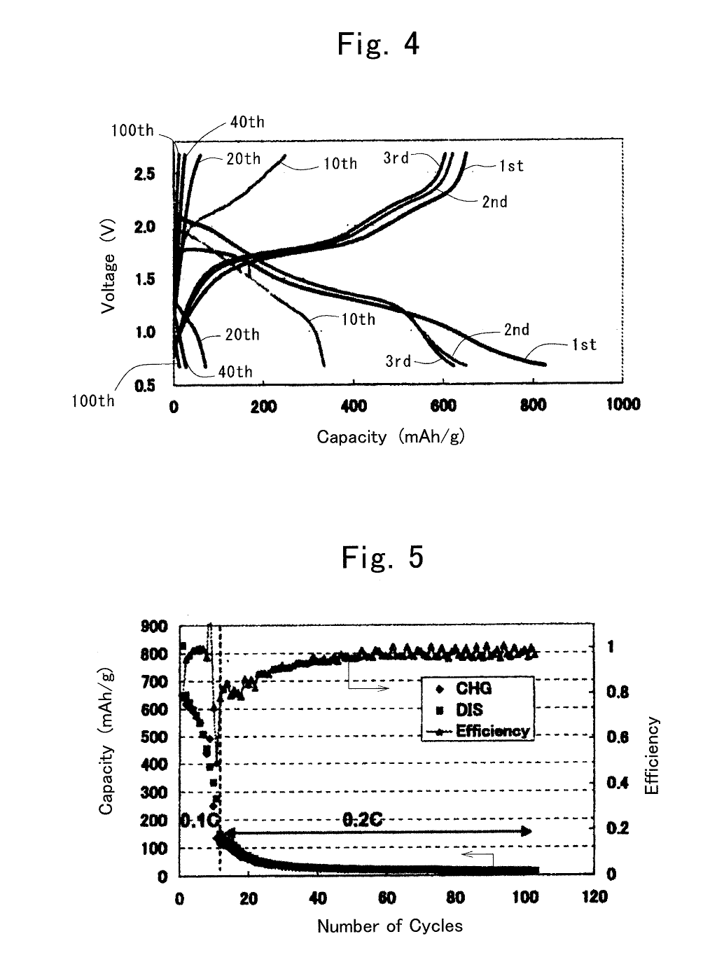

Charging and discharging characteristics of the sodium-ion secondary battery according to Example No. 1 were measured. To be concrete, charging and discharging were carried out repeatedly for 100 cycles at a rate of 0.2 C (i.e., equivalent to 500 mAh/g by conversion) after carrying out charging and discharging for 10 cycles while setting an electric-current value per 1 gram of the positive-electrode active material at a rate of 0.1 C. The cut-off voltage on this occasion was from 2.67 V to 0.67 V. The temperature thereon was 25° C. The resulting charging and discharging curves are shown in FIG. 4, and the resultant cyclability is shown in FIG. 5.

As can be seen from FIGS. 4 and 5, although it was feasible to do charging and discharging reversibly during a couple of the initial cycles, it is not possible to say that the cyclability was sufficient because it degraded at 10 cycles approximately.

### Example No. 2

### (1) Positive Electrode

The same sodium-ion half-cell as that in Example No. 1 was assembled. The resulting half-cell was charged and discharged at 25° C. for 1 cycle at a rate of 0.1 C (i.e., equivalent to 500 mAh/g by conversion), namely, at an electric-current value per 1 gram of the positive-electrode active material, so that it was put in a state where no sodium was present in the positive electrode. The cut-off voltage on this occasion was from 2.67 V to 0.67 V.

### (2) Negative Electrode

93 parts by mass of hard carbon (e.g., “Carbotron P,” a product of KREHA Corporation), 2 parts by mass of KETJENBLACK (or KB), 5 parts by mass of polyvinylidene fluoride, and N-methyl-2-pyrolidone (or NMP) were mixed one another to make a slurry. This slurry was coated onto one of the opposite surfaces of a copper foil, and was roll pressed to 60 μm in thickness after being dried. Then, the coated copper foil was heat treated under a reduced pressure at 170° C. for 10 hours, and was thereafter punched out to a size with φ11 mm in diameter to obtain a negative electrode.

Other than using this hard-carbon electrode instead of the positive electrode in Example No. 1, a sodium half-cell was assembled while using metallic sodium as the counter electrode in the same manner as Example No. 1. The resulting half-cell was charged and discharged at 25° C. for 1.5 cycles at a rate of 0.1 C (i.e., equivalent to 250 mAh/g by conversion), namely, at an electric-current value per 1 gram of the negative-electrode active material, so that it was put in a state where sodium was fully inserted into the negative electrode. The cut-off voltage on this occasion was from 1.0 V to 0.0 V.

### (3) Electrolytic Solution

As for an electrolytic solution, a nonaqueous electrolytic solution was used in which NaClO₄ had been dissolved in propylene carbonate. The concentration of NaClO₄ was 1.0 mol/L within the electrolytic solution.

### (4) Battery

Note only the half-cell obtained in (1) above was disassembled to take out the positive electrode, but also the other half-cell obtained in (2) above was disassembled to take out the negative electrode. Other than using these electrodes as a positive electrode and a negative electrode, respectively, a sodium-ion secondary battery according to Example No. 2 was obtained in the same manner as Example No. 1.

### Charging/Discharging Test

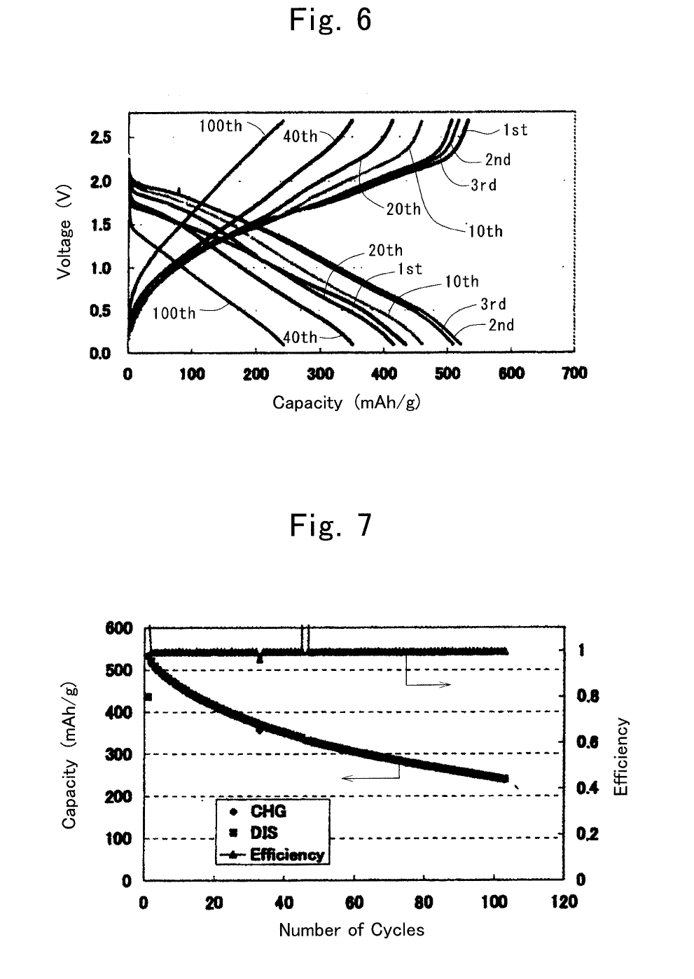

Charging and discharging characteristics of the sodium-ion secondary battery according to Example No. 2 were measured. To be concrete, charging and discharging were carried out repeatedly for 100 cycles while setting an electric-current value per 1 gram of the positive-electrode active material at a rate of 0.1 C (i.e., equivalent to 500 mAh/g by conversion). The cut-off voltage on this occasion was from 2.7 V to 0.1V. The temperature thereon was 25° C. The resulting charging and discharging curves are shown in FIG. 6, and the resultant cyclability is shown in FIG. 7.

As can be seen from FIGS. 6 and 7, charging and discharging were done reversibly, and a 282-mAh/g capacity was obtainable even after 100 cycles.

### Example No. 3

### (1) Positive Electrode

60 parts by mass of the same sulfur-based positive-electrode active material as that in Example No. 1, 20 parts by mass of KETJENBLACK (or KB), 20 parts by mass of polyimide (or PI), and N-methyl-2-pyrolidone (or NMP) were mixed one another to make a slurry.

Meanwhile, a current collector was prepared which was made by punching out a carbon paper (e.g., “TGP-H-030,” a product of TORAY Corporation) to φ11 mm in diameter. After filling up the resulting current collector with the aforementioned slurry, it was dried under a reduced pressure at 200° C. for 1 hours, thereby making a positive electrode. Since the weight of the current collector was 7.95 mg, and since the weight of the positive electrode was 14.22 mg after being filled up with the slurry and dried, the weight of the mixed raw material came to be (14.22−7.95)×60%=3.762 mg within the positive-electrode active material.

### (2) Negative Electrode

For a negative electrode, a disk-shaped sodium foil was used which was formed to about 0.5 mm in thickness and about φ13 mm in diameter by slicing metallic sodium.

### (3) Electrolytic Solution

As for an electrolytic solution, a nonaqueous electrolytic solution was used in which NaClO₄ had been dissolved in propylene carbonate. The concentration of NaClO₄ was 1.0 mol/L within the electrolytic solution.

### (4) Battery

Using the positive electrode, negative electrode and electrolytic solution obtained (1), (2) and (3) above, a metallic sodium battery according to Example No. 3 was made in the same manner as Example No. 1.

### Charging/Discharging Test

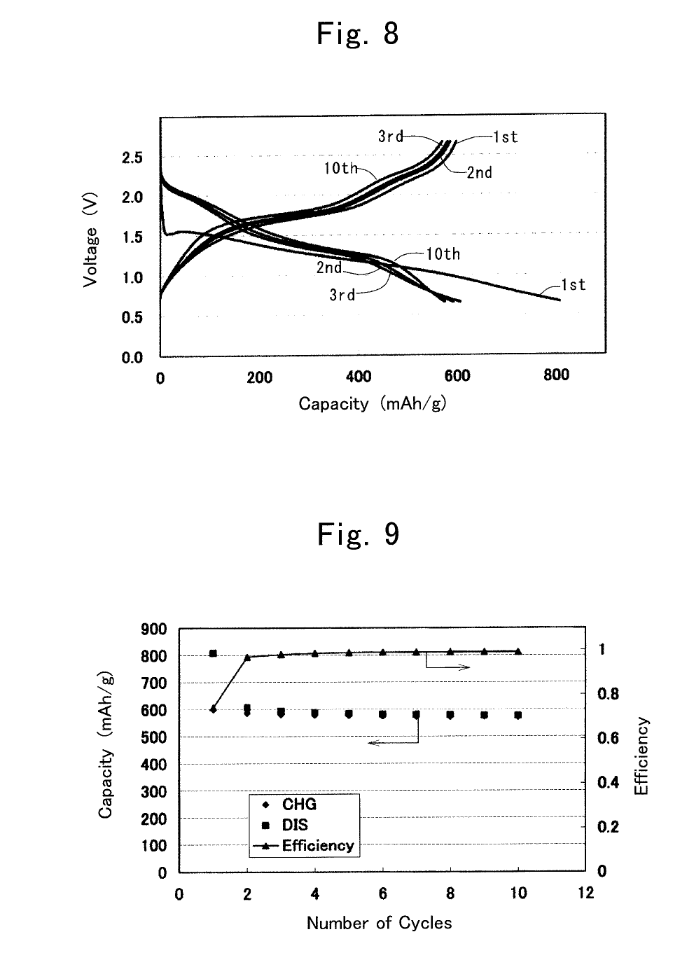

Charging and discharging characteristics of the metallic sodium battery according to Example No. 3 were measured. To be concrete, charging and discharging were carried out repeatedly at a rate of 0.1 C (i.e., equivalent to 600 mAh/g by conversion), namely, at an electric-current value per 1 gram of the positive-electrode active material. The cut-off voltage on this occasion was from 2.67 V to 0.67 V. The temperature thereon was 25° C. The resulting charging and discharging curves are shown in FIG. 8, and the resultant cyclability is shown in FIG. 9.

As can be seen from FIGS. 8 and 9, an 807-mAh/g capacity was demonstrated in the first discharging, and a 606-mAh/g capacity was demonstrated in the second discharging. And, charging and discharging were done reversibly, and about 600-mAh/g charging and discharging capacities were obtainable even after 10 cycles. The electric capacity of the positive electrode in this metallic sodium battery could be calculated as 3.762 mg×0.6 mAh/mg=2.257 mAh.

### Example No. 4

### (1) Positive Electrode

60 parts by mass of the same sulfur-based positive-electrode active material as that in Example No. 1, 20 parts by mass of KETJENBLACK (or KB), 20 parts by mass of polyimide (or PI), and N-methyl-2-pyrolidone (or NMP) were mixed one another to make a slurry.

Meanwhile, a current collector was prepared which was made by punching out a carbon paper (e.g., “TGP-H-030,” a product of TORAY Corporation) to φ11 mm in diameter. After filling up the resulting current collector with the aforementioned slurry, it was dried under a reduced pressure at 200° C. for 1 hours, thereby making a positive electrode. Since the weight of the current collector was 7.95 mg, and since the weight of the positive electrode was 12.63 mg after being filled up with the slurry and dried, the weight of the mixed raw material came to be (12.63−7.95)×60%=2.808 mg within the positive-electrode active material.

The same sodium-ion half-cell as that in Example No. 1 was assembled using this positive electrode. The resulting half-cell was charged and discharged at 25° C. for 1 cycle at a rate of 0.1 C (i.e., equivalent to 500 mAh/g by conversion), namely, at an electric-current value per 1 gram of the positive-electrode active material, in order to cancel the initial irreversible capacity, so that it was put in a state where no sodium was present in the positive electrode. The cut-off voltage on this occasion was from 2.67 V to 0.67 V.

### (2) Negative Electrode

93 parts by mass of hard carbon (e.g., “Carbotron P,” a product of KREHA Corporation), 2 parts by mass of KETJENBLACK (or KB), 5 parts by mass of polyvinylidene fluoride, and N-methyl-2-pyrolidone (or NMP) were mixed one another to make a slurry. This slurry was coated onto one of the opposite surfaces of a copper foil, and was roll pressed to 60 μm in thickness after being dried. Then, the coated copper foil was heat treated under a reduced pressure at 170° C. for 10 hours, and was thereafter punched out to a size with φ11 mm in diameter to obtain a negative electrode.

Other than using this hard-carbon electrode instead of the positive electrode in Example No. 1, a sodium-ion half-cell was assembled while using metallic sodium as the counter electrode in the same manner as Example No. 1. The resulting half-cell was charged and discharged at 25° C. for 1.5 cycles at a rate of 0.1 C (i.e., equivalent to 250 mAh/g by conversion), namely, at an electric-current value per 1 gram of the negative-electrode active material, so that it was put in a state where sodium was fully inserted into the negative electrode. The cut-off voltage on this occasion was from 1.0 V to 0.0 V.

### (3) Electrolytic Solution

As for an electrolytic solution, a nonaqueous electrolytic solution was used in which NaClO₄ had been dissolved in propylene carbonate. The concentration of NaClO₄ was 1.0 mol/L within the electrolytic solution.

### (4) Battery

Note only the half-cell obtained in (1) above was disassembled to take out the positive electrode, but also the other half-cell obtained in (2) above was disassembled to take out the negative electrode. Other than using these electrodes as a positive electrode and a negative electrode, respectively, a sodium secondary battery according to Example No. 4 was obtained in the same manner as Example No. 1.

### Charging/Discharging Test

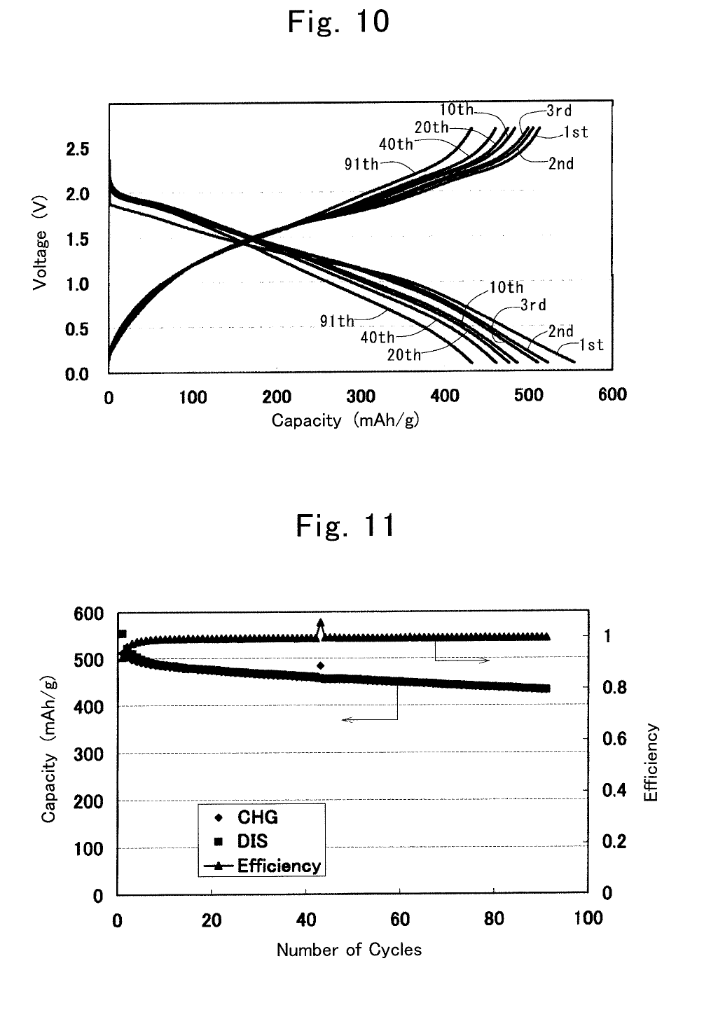

Charging and discharging characteristics of the sodium secondary battery according to Example No. 4 were measured. To be concrete, charging and discharging were carried out repeatedly for 91 cycles while setting an electric-current value per 1 gram of the positive-electrode active material at a rate of 0.1 C (i.e., equivalent to 500 mAh/g by conversion). The cut-off voltage on this occasion was from 2.7 V to 0.1 V. The temperature thereon was 25° C. The resulting charging and discharging curves are shown in FIG. 10, and the resultant cyclability is shown in FIG. 11.

As can be seen from FIGS. 10 and 11, charging and discharging were done reversibly, and a 433-mAh/g capacity was obtainable even after 91 cycles.

### INDUSTRIAL APPLICABILITY

Since the sodium secondary battery, involving sodium-ion secondary batteries, according to the present invention in this application exhibits capacities that are roughly equal to those of lithium-ion secondary batteries, it is possible to utilize it as it is in fields in which lithium-ion secondary batteries have been utilized. In particular, it is expected to utilize it as a power source for motor driving hybrid automobiles, electric automobiles, and so on.

### EXPLANATION ON REFERENCE NUMERALS

1: Reaction Apparatus; 2: Reaction Container; 3: Lid; 4: Thermocouple; 5: Gas Introduction Tube; 6: Gas Discharge Tube; and 7: Electric Furnace

1. A sodium secondary battery being characterized in that:
the sodium secondary battery is equipped with:
a positive electrode;
a negative electrode; and
a sodium-ion nonaqueous electrolyte; and
the positive electrode includes a sulfur-based positive-electrode active material containing carbon (C) and sulfur (S).

2. The sodium secondary battery as set forth in claim 1, wherein said sulfur-based positive-electrode active material comprises:
a carbon skeleton being derived from a carbon-source compound that is selected from the group consisting of polyacrylonitrile, pitches, polyisoprene, and a polycyclic aromatic hydrocarbon that is made by condensing six-membered rings in a quantity of three rings or more; and
sulfur (S) being bonded to the carbon skeleton.

3. The sodium secondary battery as set forth in claim 1, wherein a current collector comprising hard carbon is included in said negative electrode.

4. The sodium secondary battery as set forth in claim 2, wherein said sulfur-based positive-electrode active material has a carbon skeleton being derived from polyacrylonitrile; and exhibits a Raman spectrum in which a major peak exists at around 1,331 cm⁻¹, one of the Raman shifts, and other peaks exist at around 1,548 cm⁻¹, 939 cm⁻¹, 479 cm⁻¹, 381 cm⁻¹, and 317 cm⁻¹, the others of the Raman shifts, in a range of from 200 cm⁻¹ to 1,800 cm⁻¹.

5. The sodium secondary battery as set forth in claim 2, wherein said sulfur-based positive-electrode active material has a carbon skeleton being derived from pitches; and exhibits a Raman spectrum in which a major peak exists at around 1,557 cm⁻¹, one of the Raman shifts, and other peaks exist at around 1,371 cm⁻¹, 1,049 cm⁻¹, 994 cm⁻¹, 842 cm⁻¹, 612 cm⁻¹, 412 cm⁻¹, 354 cm⁻¹ and 314 cm⁻¹, the others of the Raman shifts, in a range of from 200 cm⁻¹ to 1,800 cm⁻¹, respectively.

6. The sodium secondary battery as set forth in claim 2, wherein said sulfur-based positive-electrode active material has a carbon skeleton being derived from polyisoprene; and exhibits an FT-IR spectrum in which major peaks exist at around 1,452 cm⁻¹, at around 1,336 cm⁻¹, at around 1,147 cm⁻¹, at around 1,067 cm⁻¹, at around 1,039 cm⁻¹, at around 938 cm⁻¹, at around 895 cm⁻¹, at around 840 cm⁻¹, at around 810 cm⁻¹ and at around 584 cm⁻¹, respectively.

7. The sodium secondary battery as set forth in claim 2, wherein said sulfur-based positive-electrode active material has a carbon skeleton being derived from a polycyclic aromatic hydrocarbon that is made by condensing six-membered rings in a quantity of three rings or more; and exhibits an FT-IR spectrum in which major peaks exist at around 1,056 cm⁻¹ and at around 840 cm⁻¹, respectively.

8. The sodium secondary battery as set forth in claim 1, wherein said positive electrode includes a conductor comprising sulfide of at least one member of metals that is selected from the group consisting of fourth-period metals, fifth-period metals, sixth-period metals, and rare-earth elements.

9. The sodium secondary battery as set forth in claim 8, wherein said conductor is sulfide of at least one member of metals that is selected from the group consisting of Ti, Fe, La, Ce, Pr, Nd, Sm, V, Mn, Ni, Cu, Zn, Mo, Ag, Cd, In, Sn, Sb, Ta, W, and Pb.

10. The sodium secondary battery as set forth in claim 9, wherein said conductor is at least one member being selected from the group consisting of La₂S₃, TiS₂, Sm₂S₃, Ce₂S₃, and MoS₂.

11. A vehicle having the sodium secondary battery as set forth in claim 1 on-board.
